(19) United States
(12) Patent Application Publication
(10) Pub. No.: US 2023/0330946 A1
(43) Pub. Date: Oct. 19, 2023

(54) METHOD FOR JOINING METAL AND RESIN, AND JOINED BODY THEREOF

(71) Applicant: SHOWA DENKO K.K., Tokyo (JP)

(72) Inventors: Kazuo OTANI, Kumagays-shi, Saitama (JP); Nobuyuki TAKAHASHI, Himeji-shi, Hyogo (JP); Ryota NIIBAYASHI, Kumagaya-shi, Saitama (JP)

(73) Assignee: SHOWA DENKO K.K., Tokyo (JP)

(21) Appl. No.: 18/042,492

(22) PCT Filed: Aug. 4, 2021
(86) PCT No.: PCT/JP2021/028939

§ 371 Date: Feb. 22, 2023

(30) Foreign Application Priority Data
Aug. 26, 2020 (JP) 2020-142603

(51) Int. Cl. B29C 65/64; B29C 65/32; B29C 65/54

(52) U.S. Cl. CPC B29C 65/64; B29C 65/32; B29C 65/54

(57) ABSTRACT

The present invention relates to a method for bonding a metal and a resin, including bonding a metal and a resin by high-frequency induction welding via an intermediate resin layer which causes a chemical reaction.

### TECHNICAL FIELD

The present invention relates to a method for bonding a metal and a resin by high-frequency induction welding, and a bonded article thereof.

### BACKGROUND ART

In transportation equipment including automobiles, weight reduction has become an important problem from the viewpoint of reducing CO₂ emissions and energy saving. In order to solve such problem, technology development for multi-materialization has been actively advanced in recent years.

Multi-materialization is a technique for reducing the weight of a material and increasing the strength of the material by using materials having different functions and characteristics (hereinafter, also referred to as different kinds of materials) such as a high tensile strength steel sheet (High Tensile Strength Steel), aluminum, and resins such as carbon fiber reinforced plastic (CFRP) in combination. For the realization of multi-materialization, bonding technology of different kinds of materials is indispensable.

Conventionally, as a bonding method of different kinds of materials, a method of fastening by a rivet or a method of bonding by an adhesive has been mainstream.

The fastening by the rivet is a point-like bonding (point bonding), and is inferior to the fatigue property in comparison with a planar bonding (plane bonding) using an adhesive. For this reason, the application use of the fastening by the rivet is limited, for example, it is not preferable to apply the rivet to an automotive member requiring steering stability.

On the other hand, adhesion with an adhesive has advantages such as that plane bonding is possible, so that even when thin film-like different kinds of materials are subjected to bonding, excellent fatigue characteristics are exhibited, and that weight reduction can be achieved by eliminating the need for fastening parts, but has a problem that it takes time until the adhesive hardens and sufficient bonding force is obtained.

As a bonding method for solving the problems in the fastening by rivets and the bonding by an adhesive as described above, a bonding using high-frequency induction welding (welding by electromagnetic induction heating) is disclosed (PTL 1 and PTL 2).

For example, PTL 1 discloses a production method in which a coated shaped metal material including an organic resin layer having a thickness of 0.2 μm or more and a thermoplastic resin are caused to generate heat by electromagnetic induction to be welded together. Specifically, a method for producing a composite by bonding a metal provided with a polypropylene-based organic material layer and a molded body of a polypropylene-based composition is disclosed.

Further, PTL 2 discloses a thermoplastic composite molded body in which a member made of a magnetic body and/or a conductor and a thermoplastic resin are integrated by welding by electromagnetic induction heating with a thermoplastic elastomer resin composition interposed between them. Specifically, there is disclosed a method in which a thermoplastic elastomer resin composition containing a hard segment composed of a crystalline aromatic polyester unit and a soft segment composed of an aliphatic polyether unit and/or an aliphatic polyester is interposed therebetween, and a metal and a polyester block copolymer are integrated by welding by electromagnetic induction heating.

### CITATION LIST

### Patent Literature

PTL 1: JP 2018-34437 A
PTL 2: JP 2019-59204 A

### SUMMARY OF INVENTION

### Technical Problem

In the bonding by the conventional high-frequency induction welding described in PTL 1, PTL 2, and the like, although the problems in the bonding by the fastening by the rivet and the bonding by the adhesive can be solved, in the bonding using metals and resins as the different kinds of materials, there is a problem that it is difficult to obtain a sufficient bonding strength.

The present invention has been made in view of such a technical background, and an object of the present invention is to provide a method for bonding metals and resins, which can perform bonding of metals and resins with sufficient bonding strength by high-frequency induction welding, and a bonded article thereof.

### Solution to Problem

That is, the present invention provides the following means.

[1] A method for bonding a metal and a resin, including: bonding a metal and a resin by high-frequency induction welding via an intermediate resin layer which causes a chemical reaction by high-frequency induction welding.

[2] The method for bonding a metal and a resin as set forth in [1], wherein the intermediate resin layer is a primer layer laminated on the metal, and at least an outermost surface layer of the primer layer is an in-situ polymerization type polymer layer obtained by polymerizing an in-situ polymerization type composition above the metal.

[3] The method for bonding a metal and a resin as set forth in [1], wherein the intermediate resin layer is a thermoplastic resin film which is obtained by causing an in-situ polymerization type composition to undergo at least one reaction selected from a polyaddition reaction and a radical polymerization reaction, and which further causes the reaction by the high-frequency welding.

[4] The method for bonding a metal and a resin as set forth in [1], wherein the intermediate resin layer is a multilayer structure film including: a thermoplastic resin layer obtained by causing an in-situ polymerization type composition to undergo at least one reaction selected from a polyaddition reaction and a radical polymerization reaction; and a thermosetting resin layer in a B-stage state.

[5] The method for bonding a metal and a resin as set forth in any one of [2] to [4], wherein the in-situ polymerization type composition contains at least one member selected from the following (a) to (g):
(a) a combination of a bifunctional isocyanate compound and a bifunctional hydroxy compound;
(b) a combination of a bifunctional isocyanate compound and a bifunctional amino compound;
(c) a combination of a bifunctional isocyanate compound and a bifunctional thiol compound;
(d) a combination of a bifunctional epoxy compound and a bifunctional hydroxy compound;
(e) a combination of a bifunctional epoxy compound and a bifunctional carboxy compound;
(f) a combination of a bifunctional epoxy compound and a bifunctional thiol compound;
(g) a combination of monofunctional radical polymerizable monomers.

[6] The method for bonding a metal and a resin as set forth in [5], wherein the in-situ polymerization type composition further includes a maleic anhydride modified polyolefin.

[7] The method for bonding a metal and a resin as set forth in [5] or [6], wherein the in-situ polymerization type composition further includes at least one selected from a carboxy group-terminated butadiene nitrile rubber, an aromatic polyetherketone, a silicone elastomer, and an acrylic resin.

[8] The method for bonding a metal and a resin as set forth in [4], wherein the thermosetting resin layer in a B-stage state causes a crosslinking reaction by the high-frequency welding.

[9] The method for bonding a metal and a resin as set forth in [4], wherein the thermosetting resin layer in a B-stage state of the multilayer structure film is directly bonded to the metal, and the thermoplastic resin layer of the multilayer structure film is directly bonded to the resin.

[10] The method for bonding a metal and a resin as set forth in any one of [4], [8], and [9], wherein the thermosetting resin layer in a B-stage state is formed by radical polymerization of an unsaturated group or ring-opening polymerization of an epoxy group.

[11] The method for bonding a metal and a resin as set forth in any one of [1] to [10], wherein the bonding surface of the metal on the resin side is subjected to at least one surface treatment selected from a degreasing treatment, an etching treatment, a plasma treatment, a corona discharge treatment, a UV ozone treatment, and a functional group-imparting treatment.

[12] The method for bonding a metal and a resin as set forth in [11], wherein the functional group-imparting treatment is a treatment of imparting a functional group to a surface of the metal by reacting a compound corresponding to at least one selected from the following (i) to (iii):
(i) an alkoxysilane compound;
(ii) a compound having at least one functional group selected from an amino group, an epoxy group, a mercapto group, and an isocyanato group; and
(iii) a compound having a radical reactive group.

[13] A bonded article of a metal and a resin obtained by the method for bonding a metal and a resin as set forth in any one of [1] to [12].

### Advantageous Effects of Invention

According to the bonding method for metals and resins of the present invention, it is possible to perform bonding of metals and resins with sufficient bonding strength by high-frequency induction welding.

Therefore, according to the present invention, it is possible to provide a bonded article in which metals and resins are bonded with sufficient bonding strength by high-frequency induction welding.

### BRIEF DESCRIPTION OF DRAWINGS

FIG. 1 is an explanatory diagram showing a configuration of a bonded article according to one aspect of the present invention.

FIG. 2 is an explanatory diagram showing a configuration of a bonded article according to one aspect of the present invention.

FIG. 3 is an explanatory diagram showing a configuration of a bonded article according to another aspect of the present invention.

FIG. 4 is an explanatory diagram showing a configuration of a bonded article according to another aspect of the present invention.

FIG. 5 is an explanatory diagram showing a configuration of a bonded article according to still another aspect of the present invention.

FIG. 6 is an explanatory diagram showing a configuration of a bonded article according to still another aspect of the present invention.

### DESCRIPTION OF EMBODIMENTS

Hereinafter, the present invention will be described in detail, but the present invention is not limited to the embodiments described later.

### [Bonding Method of Metals and Resins]

The bonding method of the present embodiment is a method for bonding a metal and a resin, including bonding a metal and a resin by high-frequency induction welding via an intermediate resin layer which causes a chemical reaction by high-frequency induction welding.

In the present embodiment, the chemical reaction means that the substance is changed into another substance by a reaction, and means that it is changed by synthesis, cyclization, decomposition, condensation, polymerization, oxidation, reduction, rearrangement, addition, or the like.

The high-frequency induction welding refers to a method of melting and welding a material from the inside thereof by dielectric heating with high-frequency waves. Specifically, the high-frequency induction welding is a method including generating a magnetic field by flowing an alternating current through a coil-shaped lead wire, placing a metal in the magnetic field to cause the metal to generate heat by electromagnetic induction, and melting and welding a resin or the like by the heat. In the present embodiment, by performing bonding by high-frequency induction welding, it is possible to perform bonding between the metal and the resin with sufficient bonding strength. In addition, it is possible to perform bonding between the metal and the resin in a relatively short time. Furthermore, it is possible to provide a bonded article in which the metal and the resin are bonded with sufficient bonding strength.

Regarding the bonding between the metal and the resin, the metal, the intermediate resin layer, and the resin may be bonded at one time, the metal and the intermediate resin layer may be bonded followed by bonding of the resin, or the resin and the intermediate resin layer may be bonded followed by bonding of the metal. From the viewpoint of production efficiency, it is preferable to perform bonding the metal, the intermediate resin layer, and the resin at one time.

### <Metal>

The metal is not particularly limited, and examples thereof include iron, copper, aluminum, magnesium, and titanium.

In the present embodiment, the term “iron” is used to include iron and an alloy thereof. Examples of the iron alloy include steel. Similarly, copper, aluminum, magnesium, titanium and the like are also used in the meaning of including these simple substances and alloys thereof.

Among these, aluminum is preferable from the viewpoint of weight reduction, processability, and the like, and from the viewpoint of multi-material applications used in automobiles and the like.

### [Surface Treatment]

From the viewpoint of improving the adhesiveness between the metal and the intermediate resin layer and improving the bonding strength between the metal and the resin, it is preferable to perform a surface treatment on the bonding surface of the metal with the resin. The bonding strength between the metal and the resin is improved by removing contaminants on the metal surface, roughening the metal surface for the purpose of an anchor effect, imparting a functional group to the metal surface, and the like by the surface treatment.

Examples of the surface treatment include washing with a solvent or the like, degreasing treatment, blasting treatment, polishing treatment (sanding treatment), plasma treatment, corona discharge treatment, laser treatment, UV ozone treatment, etching treatment, chemical conversion treatment, and functional group-imparting treatment. The surface treatment is appropriately selected depending on the metal. The surface treatment may be carried out alone or in combination of two or more kinds thereof. Among them, degreasing treatment, polishing treatment, plasma treatment, corona discharge treatment, UV ozone treatment, etching treatment, and functional group-imparting treatment are preferable, and plasma treatment, etching treatment, and functional group-imparting treatment are preferable.

As the surface treatment limited to aluminum, degreasing treatment, etching treatment, and functional group-imparting treatment are more preferable, and as the surface treatment of metals in general, degreasing treatment, plasma treatment, etching treatment, and functional group-imparting treatment are more preferable.

As a specific method of the surface treatment, a known method can be applied.

Examples of the washing with a solvent or the like and the degreasing treatment include a method in which dirt such as oil and fat on the surface of the metal is dissolved and removed with an organic solvent such as acetone or toluene. The washing with a solvent or the like and the degreasing treatment are preferably performed before other surface treatments are performed.

Examples of the blasting treatment include a shot blasting treatment, a sand blasting treatment, and a wet blasting treatment.

Examples of the polishing treatment include buffing using a polishing cloth, roll polishing using polishing paper (sandpaper), and electrolytic polishing.

The plasma treatment is a method in which a metal surface is struck by a plasma beam emitted from a rod using a plasma treatment high-voltage power supply, a foreign matter oil film present on the surface is first cleaned, and then gas energy is input to excite surface molecules. Specific examples thereof include an atmospheric pressure plasma treatment method capable of imparting a hydroxy group or a polar group to a metal surface.

The corona discharge treatment is a treatment in which a metal is sandwiched between a pair of electrodes under atmospheric pressure emitted from the electrodes, and an alternating high voltage is applied between both electrodes to excite corona discharge, thereby exposing the surface of the metal to corona discharge. Examples of the corona generating gas include helium, argon, nitrogen, carbon monoxide, carbon dioxide, and oxygen, and a mixed gas of these gases may also be used.

The laser treatment is a technique for improving the characteristics of a metal surface by rapidly heating and cooling only the metal surface layer by laser irradiation, and can roughen the metal surface. The laser treatment may be performed using a known laser treatment technique.

The UV ozone treatment is a method of cleaning or modifying surfaces by the energy of short-wavelength ultraviolet rays emitted from a low-pressure mercury lamp and the power of ozone (O₃) generated thereby. In general, a cleaning surface modifying apparatus using a low-pressure mercury lamp is called “UV ozone cleaner”, “UV cleaning apparatus”, “ultraviolet surface modifying apparatus”, or the like.

Examples of the etching treatment include chemical etching treatments such as an alkali method, a phosphoric acid-sulfuric acid method, a fluoride method, a chromic acid-sulfuric acid method, and a salt iron method, and electrochemical etching treatments such as an electrolytic etching method.

When aluminum is used as the metal, a caustic soda method using a sodium hydroxide aqueous solution or a potassium hydroxide aqueous solution is preferable, and a caustic soda method using a sodium hydroxide aqueous solution is more preferable. In the caustic soda method, for example, metals are preferably immersed in a sodium hydroxide or potassium hydroxide aqueous solution having a concentration of 3 to 20% by mass at 20 to 70° C. for 1 to 15 minutes, neutralized (desmutted) with a 1 to 20% by mass nitric acid aqueous solution or the like after the immersion, washed with water, and dried. A chelating agent, an oxidizing agent, a phosphate, or the like may be added as an additive.

The chemical conversion treatment is to form a chemical conversion film on the surface of a metal.

Examples of the chemical conversion treatment include a boehmite treatment and a zirconium treatment.

As the boehmite treatment, a known boehmite treatment or the like can be used. The boehmite treatment is, for example, a treatment in which aluminum is subjected to a hydrothermal treatment to form a boehmite film on the surface thereof. As a reaction accelerator, ammonia, triethanolamine or the like may be added to water. For example, aluminum is preferably immersed in 90 to 100° C. hot water containing triethanolamine at a concentration of 0.1 to 5.0% by mass for 3 seconds to 5 minutes.

As the zirconium treatment, a known zirconium treatment or the like can be used. The zirconium treatment is, for example, a treatment of forming a zirconium salt film on the surface of aluminum using a zirconium compound such as zirconium phosphate or a zirconium salt. For example, aluminum is preferably immersed for 0.5 to 3 minutes in a 45 to 70° C. solution of a conversion agent for zirconium treatment such as “PALCOAT 3762” or “PALCOAT 3796” (both manufactured by Nihon Parkerizing Co., Ltd.). The zirconium treatment is preferably carried out after the etching treatment by the caustic soda method.

The functional group-imparting treatment is a treatment for imparting a functional group to the surface of a metal.

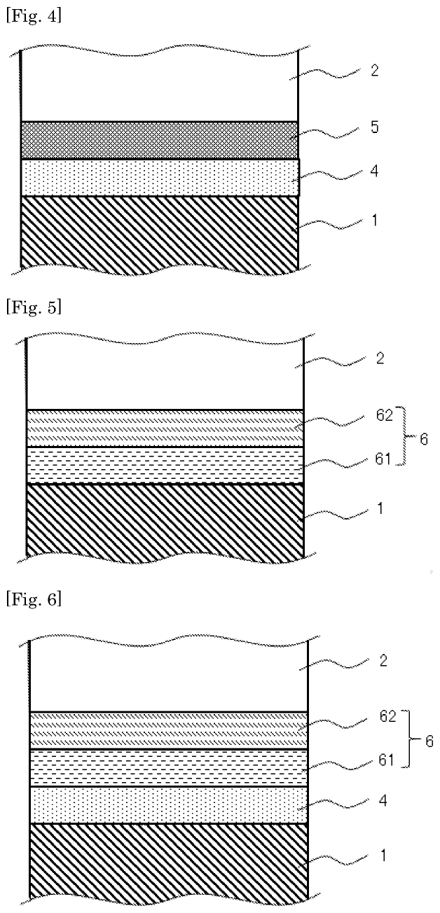

By the functional group-imparting treatment, as shown in FIG. 2, FIG. 4, and FIG. 6, one or more functional group-containing layers 4 laminated in contact with the metal and the intermediate resin layer can be formed between the metal and the intermediate resin layer.

In the case where the functional group-containing layer 4 is formed on the metal surface by the functional group-imparting treatment, the functional group contained in the functional group-containing layer 4 reacts with the functional group on the metal surface and the functional group contained in the resin constituting the intermediate resin layer, respectively to form a chemical bond, thereby obtaining an effect of improving the adhesiveness between the metal and the intermediate resin layer. In addition, an effect of improving the bonding strength between the metal and the resin is also obtained.

The functional group-imparting treatment is preferably performed after the metal surface is subjected to a surface treatment for the purpose of cleaning, anchor effect, or the like, such as washing with a solvent or the like, degreasing treatment, blasting treatment, polishing treatment, plasma treatment, laser treatment, UV ozone treatment, etching treatment, or chemical conversion treatment.

In particular, when the intermediate resin layer is a thermoplastic resin film or a multilayer structure film to be described later, it is preferable to perform a functional group-imparting treatment from the viewpoint of obtaining sufficient bonding strength.

The functional group-imparting treatment is preferably a treatment in which a functional group such as a hydroxy group originally present on the metal surface or newly generated by the surface treatment is reacted with a compound corresponding to at least one selected from the following (i) to (iii) to impart a functional group derived from the compound to the metal surface:
(i) an alkoxysilane compound;
(ii) a compound having at least one functional group selected from an amino group, an epoxy group, a mercapto group, and an isocyanato group; and
(iii) a compound having a radical reactive group.

### (Alkoxysilane Compound)

A specific example of the alkoxysilane compound is a silane coupling agent, and a compound having a functional group such as an amino group, an epoxy group, a mercapto group, a styryl group, a (meth)acryloyl group, or an isocyanato group is preferable.

Specific examples of the silane coupling agent include vinyltrimethoxysilane and vinyltriethoxysilane having a vinyl group; 2-(3,4-epoxycyclohexyl)ethyltrimethoxysilane having an epoxy group; 3-glycidoxypropylmethyldimethoxysilane, 3-glycidoxypropylmethyltrimethoxysilane, 3-glycidoxypropylmethyldiethoxysilane, 3-glycidoxypropylmethyldiethoxysilane, and 3-glycidoxypropyltriethoxysilane having a glycidyl group; p-styryltrimethoxysilane having a styryl group; 3-methacryloyloxypropylmethyldimethoxysilane, 3-methacryloyloxypropyltrimethoxysilane, 3-methacryloyloxypropylmethyldiethoxysilane, and 3-methacryloyloxypropyltriethoxysilane having a methacryloyloxy group; 3-acryloyloxypropyltrimethoxysilane having an acryloyloxy group; N-2-(aminoethyl)-3-aminopropylmethyldimethoxysilane, N-2-(aminoethyl)-3-aminopropylmethyldimethoxysilane, N-2-(aminoethyl)-3-aminopropyltrimethoxysilane, 3-aminopropyltrimethoxysilane, 3-aminopropyltriethoxysilane, 3-triethoxysilyl-N-(1,3-dimethyl-butylidene)propylamine, N-phenyl-3-aminopropyltrimethoxysilane, and N-(vinylbenzyl)-2-aminopropyltrimethoxysilane hydrochloride having an amino group; tris-(trimethoxysilylpropyl)isocyanurate having an isocyanurate group; 3-ureidopropyltrialkoxysilane having a ureido group; 3-mercaptopropylmethyldimethoxysilane having a mercapto group; 3-isocyanatepropyltriethoxysilane having an isocyanato group; dithioltriazinepropyltriethoxysilane having a triazine mercapto group; and 6-(triethoxysilylpropylamino)-1,3,5-triazine-2,4-dithiol monosodium salt (TES) having an ethoxysilyl group and a mercapto group.

Among them, 3-aminopropyltrimethoxysilane and 3-methacryloyloxypropyltrimethoxysilane are preferable from the viewpoint of obtaining sufficient bonding strength.

The method for imparting a functional group with the silane coupling agent is not particularly limited, and examples thereof include a spray coating method and an immersion method.

In the immersion method, an aqueous solution of a silane coupling agent having a low concentration or an organic solvent solution of a silane coupling agent having a low concentration is brought into contact with the surface of a metal, whereby a hydroxy group or the like present on the surface of the metal reacts with the silane coupling agent to generate a silanol group, and an oligomerized silanol group is bonded to the surface of the metal. To be specific, for example, a functional group chemically bonded to the surface of a metal can be introduced by heating a diluted solution obtained by diluting a silane coupling agent with an organic solvent to a concentration of about 0.5% by mass to 50% by mass from room temperature to 100° C. and immersing a material in the diluted solution for 1 minute to 5 days.

In addition, in the spray coating method, a silane coupling agent itself or a silane coupling agent diluted with an organic solvent is sprayed onto the surface of a metal, and a drying treatment is performed at room temperature to 100° C. for 1 minute to 5 hours. A strong chemical bond is formed through the drying treatment, and a functional group chemically bonded to the surface of the metal can be introduced.

In the method for imparting a functional group with the silane coupling agent, the surface to which the functional group has been introduced by the silane coupling agent is preferably washed with an organic solvent, alcohol, water, or the like. The bonding strength between the metal and the resin can be improved by removing the silane coupling agent or the compound derived from the silane coupling agent remaining on the functional group introduced by the chemical bond with a weak adsorption force by washing.

### (Compound Having Amino Group)

Specific examples of the compound having an amino group include an amino compound having a (meth)acryloyl group and an amino compound having two or more amino groups. Examples of the amino compound include, but are not limited to, (meth)acrylamide, ethylenediamine, 1,2-propanediamine, 1,3-propanediamine, 1,4-diaminobutane, hexamethylenediamine, 2,5-dimethyl-2,5-hexanediamine, 2,2,4-trimethylhexamethylenediamine, diethylenetriamine, triethylenetetramine, tetraethylenepentamine, pentaethylenehexamine, 4-aminomethyloctamethylenediamine, 3,3′-iminobis(propylamine), 3,3′-methyliminobis(propylamine), bis(3-aminopropyl)ether, 1,2-bis(3-aminopropyloxy)ethane, menthenediamine, isophoronediamine, bisaminomethylnorbornane, bis(4-aminocyclohexyl)methane, bis(4-amino-3-methylcyclohexyl)methane, 1,3-diaminocyclohexane, 3,9-bis(3-aminopropyl)-2,4,8,10-tetraoxaspiro[5,5]undecane, and aminoethylpiperazine.

The method of treating with the compound having an amino group is not particularly limited, and examples thereof include a spray coating method and an immersion method. Specific examples thereof include a method of, for example, heating a diluted solution obtained by diluting the compound having an amino group with an organic solvent to a concentration of about 5% by mass to 50% by mass from room temperature to 100° C., immersing a material in the diluted solution for 1 minute to 5 days, removing the material, and drying the material at room temperature to 100° C. for 1 minute to 5 hours.

In the method of treating with the compound having an amino group, it is preferable that the surface to which a functional group has been introduced by the compound having an amino group is washed with an organic solvent or the like. The bonding strength between the metal and the resin can be improved by removing the compound having an amino group or the compound derived from the compound having an amino group remaining on the functional group introduced with a strong bond with a weak adsorption force by washing.

### (Compound Having Epoxy Group)

Specific examples of the compound having an epoxy group include an epoxy compound having a (meth)acryloyl group, an epoxy compound having an alkenyl group, and an epoxy compound having two or more functional groups. Examples thereof include glycidyl (meth)acrylate, allyl glycidyl ether, 1,6-hexanediol diglycidyl ether, and an epoxy resin having two or more epoxy groups in the molecule. It may also be an alicylic epoxy compound, and examples thereof include 3,4-epoxycyclohexylmethyl methacrylate (for example, “CYCLOMER M100” (manufactured by Daicel Corporation)), 1,2-epoxy-4-vinylcyclohexane (for example, “CELLOXIDE 2000” (manufactured by Daicel Corporation)), and 3′,4′-epoxycyclohexylmethyl 3,4-epoxycyclohexanecarboxylate (for example, “CELLOXIDE 2021P” (manufactured by Daicel Corporation)).

The method for imparting a functional group with the compound having an epoxy group is not particularly limited, and examples thereof include a spray coating method and an immersion method.

In the immersion method, by bringing a low-concentration organic solvent solution of a compound having an epoxy group and an amine-based or phosphorus-based catalyst into contact with the surface of the metal, a functional group can be imparted by reacting a hydroxy group or the like present on the surface of the metal with the epoxy group. To be specific, for example, a functional group chemically bonded to the surface of a metal can be introduced by heating a diluted solution obtained by diluting a compound having an epoxy group containing 0.5% by mass to 5% by mass of a catalyst with an organic solvent to a concentration of about 0.5% by mass to 50% by mass from room temperature to 100° C. and immersing a material in the diluted solution for 1 minute to 5 days. In addition, in the spray coating method, a diluted solution obtained by diluting the compound having an epoxy group contained in an amount of 0.5 to 5% by mass with an organic solvent to a concentration of about 0.5% by mass to 50% by mass is sprayed onto the surface of the metal, and a drying treatment is performed at room temperature to 100° C. for 1 minute to 5 hours. A strong chemical bond is formed through the drying treatment, and a functional group chemically bonded to the surface of the metal can be introduced.

As the amine-based or phosphorus-based catalyst, known catalysts can be used. Examples of the amine-based catalyst include, but are not particularly limited to, triethylenediamine, tetramethylguanidine, N,N,N′,N′-tetramethylhexane-1,6-diamine, dimethyl ether amine, N,N,N′,N″,N″-pentamethyldipropylenetriamine, N-methylmorpholine, bis(2-dimethylaminoethyl)ether, dimethylaminoethoxyethanol, and triethylamine. Examples of the phosphorus-based catalyst include, but are not particularly limited to, triphenylphosphine, benzyltriphenylphosphonium chloride, and n-butyltriphenylphosphonium bromide.

In the method for imparting a functional group with the compound having an epoxy group, it is preferable that the surface to which a functional group has been introduced by the compound having an epoxy group is washed with an organic solvent or the like. The bonding strength between the metal and the resin can be improved by removing the compound having an epoxy group or the compound derived from the compound having an epoxy group remaining on the functional group introduced by the chemical bond with a weak adsorption force by washing.

### (Compound Having Mercapto Group)

Specific examples of the compound having a mercapto group are thiol compounds having two or more functional groups, thiol compounds having an alkenyl group, and the like.

As the thiol compound, a thiol compound having three or more functional groups or a compound having an alkenyl group in addition to a mercapto group is preferable. The thiol compound is not particularly limited, and examples thereof include pentaerythritol tetrakis(3-mercaptopropionate) (for example, “QX40” (manufactured by Mitsubishi Chemical Corporation), “QE-340M” (manufactured by Toray Fine Chemicals Co., Ltd.)), ether-based primary thiol (for example, “Capcure 3-800” (manufactured by Cognis)), 1,4-bis(3-mercaptobutyryloxy)butane (for example, “KarenzMT (registered trademark) BD1” (manufactured by Showa Denko K.K.)), pentaerythritol tetrakis(3-mercaptobutyrate) (for example, “KarenzMT (registered trademark) PE1” (manufactured by Showa Denko K.K.)), and 1,3,5-tris(3-mercaptobutyloxyethyl)-1,3,5-triazine-2,4,6(1H,3H,5H)-trione (for example, “KarenzMT (registered trademark) NR1” (manufactured by Showa Denko K.K.)). Among them, pentaerythritol tetrakis(3-mercaptobutyrate) is preferable because of its stability in epoxy resin.

The method of treating with the thiol compound is not particularly limited, and examples thereof include a spray coating method and an immersion method. Specific examples thereof include a method of, for example, heating a diluted solution obtained by diluting the thiol compound with an organic solvent to a concentration of about 5% by mass to 50% by mass from room temperature to 100° C., immersing a material in the diluted solution for 1 minute to 5 days, removing the material, and drying the material at room temperature to 100° C. for 1 minute to 5 hours. The diluted solution of the thiol compound may contain an amine as a catalyst.

In the method of treating with the thiol compound, it is preferable that the surface to which a functional group has been introduced by the thiol compound is washed with an organic solvent or the like. The bonding strength between the metal and the resin can be improved by removing the thiol compound or the compound derived from the thiol compound remaining on the functional group introduced by the chemical bond with a weak adsorption force by washing.

### (Compound Having Isocyanato Group)

Specific examples of the compound having an isocyanato group include an isocyanato compound having a (meth)acryloyl group and an isocyanato compound having two or more functional groups. The isocyanate compound is not particularly limited, and examples thereof include 2-isocyanatoethyl methacrylate (for example, “Karenz MOI” (registered trademark) (manufactured by Showa Denko K.K.)), 2-isocyanatoethyl acrylate (for example, “Karenz AOI” (registered trademark) (manufactured by Showa Denko K.K.)), and 1,1-(bisacryloyloxyethyl)ethyl isocyanate (for example, “Karenz BEI (registered trademark)” (manufactured by Showa Denko K.K.)) which are isocyanate compounds having a (meth)acryloyl group, and diphenylmethane diisocyanate (MDI), hexamethylene diisocyanate (HDI), tolylene diisocyanate (TDI), and isophorone diisocyanate (IPDI) which are polyfunctional isocyanates.

The method of treating with the isocyanate compound is not particularly limited, and examples thereof include a spray coating method and an immersion method. Specific examples thereof include a method of, for example, heating a diluted solution obtained by diluting the isocyanate compound with an organic solvent to a concentration of about 5% by mass to 50% by mass from room temperature to 100° C., immersing a material in the diluted solution for 1 minute to 5 days, removing the material, and drying the material at room temperature to 100° C. for 1 minute to 5 hours.

In the method of treating with the isocyanate compound, it is preferable that the surface to which a functional group has been introduced by the isocyanate compound is washed with an organic solvent or the like. The bonding strength between the metal and the resin can be improved by removing the isocyanate compound or the compound derived from the isocyanate compound remaining on the functional group introduced by the chemical bond with a weak adsorption force by washing.

### (Compound Having Radical Reactive Group)

In the description herein, the term “radical reactive group” means a functional group which reacts by a radical, and a functional group having an ethylenic carbon-carbon double bond is preferable. Specific examples of the radical reactive group include, but are not limited to, a methacryloyl group, an acryloyl group, a vinyl group, and an alkenyl group.

Specific examples of the compound having a radical reactive group include compounds having a hydroxy group, a carboxyl group, an isocyanato group, or a styryl group, and having a (meth)acryloyl group or an alkenyl group. Examples thereof include glycidyl (meth)acrylate having a glycidyl group, (meth)acrylamide having an amino group, hydroxymethyl (meth)acrylate having a hydroxy group, (meth)acrylic acid having a carboxy group, 2-isocyanatoethyl methacrylate (for example, “Karenz MOI” (registered trademark) (manufactured by Showa Denko K.K.)), and 2-isocyanatoethyl acrylate (for example, “Karenz AOI” (registered trademark) (manufactured by Showa Denko K.K.)). In addition, (meth)acrylates having two or more functional groups and terminal styrene compounds such as divinylbenzene may also be used.

The method of treating with the compound having a radical reactive group is not particularly limited, and examples thereof include a spray coating method and an immersion method. Specific examples thereof include a method of, for example, heating a diluted solution obtained by diluting the compound having a radical reactive group with an organic solvent to a concentration of about 5% by mass to 50% by mass from room temperature to 100° C., immersing a material in the diluted solution for 1 minute to 5 days, removing the material, and drying the material at room temperature to 100° C. for 1 minute to 5 hours.

In the method of treating with the compound having a radical reactive group, it is preferable that the surface to which a functional group has been introduced by the compound having a radical reactive group is washed with an organic solvent or the like. The bonding strength between the metal and the resin can be improved by removing the compound having a radical reactive group or the compound derived from the compound having a radical reactive group remaining on the functional group introduced by the chemical bond with a weak adsorption force by washing.

In the functional group-imparting treatment, the compound used for imparting a functional group is preferably a compound corresponding to (i) or (ii), more preferably an alkoxysilane compound, a compound having a mercapto group, or a compound having an isocyanato group, and still more preferably an alkoxysilane compound.

### <Resin>

The resin is not particularly limited, but is preferably a thermoplastic resin. The thermoplastic resin may be a general synthetic resin, and examples thereof include general-purpose resins such as polypropylene (PP), polyethylene (PE), polystyrene (PS), polymethylmethacrylate (PMMA), and polyvinyl chloride (PVC); polyester resins such as polycarbonate (PC), polyethylene terephthalate (PET), and polybutylene terephthalate (PBT); polyamide resins such as polyamide 6 (PA6) and polyamide 66 (PA66); general-purpose engineering plastics such as polyacetal (POM) and modified polyphenylene ether (m-PPE); super-engineering plastics such as polyetherimide (PEI), polyphenylene sulfide (PPS), polyetheretherketone (PEEK), polyamideimide (PAI), polysulfone (PSU), and liquid crystal polymer (LCP). The thermoplastic resins are not particularly limited, but from the viewpoint of obtaining bonded articles in which metals and resins are bonded with sufficient bonding strength, PP, PC, PBT, PA6, PA66, and PPS are preferable.

The resin may be composed of only resin, or may be fiber reinforced plastic (FRP) reinforced with glass fiber or carbon fiber.

The resin is preferably a molded body molded in advance, or may be formed as a coating film. Examples of the form of the resin include a bulk, a film, a sheet, and an FRP molded body. The resin may be one kind selected from these, or may be a composite of two or more kinds.

The production method and the molding method of the resin of the above-described form are not particularly limited, and in the present embodiment, a resin obtained by a known method can be applied. The resin may contain, for example, additives such as a coloring agent such as a pigment, a filler, an antioxidant, and an ultraviolet inhibitor.

### <Intermediate Resin Layer>

The intermediate resin layer in the present embodiment is a layer which causes a chemical reaction by high-frequency induction welding, and refers to a layer which is interposed between a metal and a resin to be bonded and bonds the metal and the resin.

The chemical reaction is preferably a polyaddition reaction, a radical polymerization reaction, or a crosslinking reaction from the viewpoint of obtaining sufficient bonding strength and the viewpoint of the strength of the intermediate resin layer. In addition, along with the chemical reaction, the intermediate resin layer also forms a chemical bond with a functional group present on the metal surface, so that the metal and the intermediate resin layer have strong adhesiveness.

The intermediate resin layer may be a single layer or a plurality of layers.

In one aspect of the present embodiment, it is preferable that the intermediate resin layer is a primer layer laminated on the metal, and at least an outermost surface layer of the primer layer is an in-situ polymerization type polymer layer obtained by polymerizing an in-situ polymerization type composition on the metal.

In another aspect of the present embodiment, it is preferable that the intermediate resin layer is a thermoplastic resin film which is obtained by causing an in-situ polymerization type composition to undergo at least one reaction selected from a polyaddition reaction and a radical polymerization reaction, and which further causes the reaction by the high-frequency induction welding.

In still another aspect of the present embodiment, it is preferable that the intermediate resin layer is a multilayer structure film including: a thermoplastic resin layer obtained by causing an in-situ polymerization type composition to undergo at least one reaction selected from a polyaddition reaction and a radical polymerization reaction; and a thermosetting resin layer in a B-stage state.

### [In-Situ Polymerization Type Composition]

The in-situ polymerization type composition in the present embodiment is a composition that forms a thermoplastic structure, that is, a linear polymer structure, on the site, that is, on various materials, by performing a polyaddition reaction of a composition containing a predetermined combination of reactive bifunctional compounds, or by performing a radical polymerization reaction of a composition containing a radically polymerizable monofunctional monomer. The in-situ polymerization type composition is a polymerizable composition having thermoplasticity and does not constitute a three dimensional network by a cross-linked structure, unlike a thermosetting resin constituting a three dimensional network by a cross-linked structure.

In the case of the thermoplastic resin film and the multilayer structure film, although it is not always necessary to perform all reactions on site, they are included in the “in-situ polymerization type composition” because they have common components.

The in-situ polymerization type composition preferably contains at least one member selected from the following (a) to (g):
(a) a combination of a bifunctional isocyanate compound and a bifunctional hydroxy compound;
(b) a combination of a bifunctional isocyanate compound and a bifunctional amino compound;
(c) a combination of a bifunctional isocyanate compound and a bifunctional thiol compound;
(d) a combination of a bifunctional epoxy compound and a bifunctional hydroxy compound;
(e) a combination of a bifunctional epoxy compound and a bifunctional carboxy compound;
(f) a combination of a bifunctional epoxy compound and a bifunctional thiol compound;
(g) a radical polymerizable monofunctional monomer.

The blending ratio of the two kinds of bifunctional compounds in (a) to (g) can be set in consideration of the reactivity of the polyaddition reaction of both compounds, and for example, in the case of (a), the molar equivalent ratio of the isocyanate group of the bifunctional isocyanate compound to the hydroxy group of the bifunctional hydroxy compound, that is, the molar ratio of the bifunctional isocyanate compound to the bifunctional hydroxy compound is preferably 0.7 to 1.5, more preferably 0.8 to 1.4, and still more preferably 0.9 to 1.3.

Also in the cases of (b) to (f), the blending ratio of the former bifunctional compound to the latter bifunctional compound is preferably set in the same manner as in the case of (a).

When the in-situ polymerization type composition contains at least one selected from (a) to (g) above, for example, tertiary amines such as triethyl amine and 2,4,6-tris(dimethylaminomethyl)phenol, phosphorus-based compounds such as triphenyl phosphine, and the like are suitably used as the catalyst for the polyaddition reaction.

As the polymerization initiator for the radical polymerization reaction, for example, known organic peroxides, photoinitiators, and the like are suitably used. A room-temperature radical polymerization initiator obtained by combining an organic peroxide with a cobalt metal salt or an amine may be used. Examples of the organic peroxide include those classified into ketone peroxide, peroxyketal, hydroperoxide, diallyl peroxide, diacyl peroxide, peroxyester, and peroxydicarbonate. The photopolymerization initiator is preferably one capable of initiating radical polymerization upon irradiation with light in a wavelength range of ultraviolet light to visible light. These may be used alone or in combination of two or more kinds thereof. Of these, organic peroxides are preferred.

### (Bifunctional Isocyanate Compound)

The bifunctional isocyanate compound is a compound having two isocyanato groups, and examples thereof include hexamethylene diisocyanate, tetramethylene diisocyanate, dimer acid diisocyanate, 2,4- or 2,6-tolylene diisocyanate (TDI) or a mixture thereof, p-phenylene diisocyanate, xylylene diisocyanate, and diphenylmethane diisocyanate (MDI). Among them, TDI, MDI and the like are preferable from the viewpoint of the strength of the intermediate resin layer.

### (Bifunctional Hydroxy Compound)

The bifunctional hydroxy compound is a compound having two hydroxy groups, and examples thereof include aliphatic glycol compounds such as ethylene glycol, propylene glycol, diethylene glycol, and 1, 6-hexanediol; and bifunctional phenol compounds such as bisphenol A, bisphenol F, and bisphenol S. These may be used alone or in combination of two or more kinds thereof. Among them, propylene glycol, diethylene glycol and the like are preferable from the viewpoint of the toughness of the intermediate resin layer. In the above (d), as the bifunctional hydroxy compound to be combined with the bifunctional epoxy compound, a bifunctional phenol compound is preferable, a bisphenol is more preferable, and bisphenol A and bisphenol S are still more preferable.

### (Bifunctional Amino Compound)

The bifunctional amino compound is a compound having two amino groups, and examples thereof include aliphatic diamine compounds such as ethylenediamine, 1,2-propanediamine, 1,3-propanediamine, 1,4-diaminobutane, 1,6-hexamethylenediamine, 2,5-dimethyl-2,5-hexanediamine, 2,2,4-trimethylhexamethylenediamine, isophoronediamine, bis(4-amino-3-methylcyclohexyl)methane, 1,3-diaminocyclohexane, and N-aminoethylpiperazine; and aromatic diamine compounds such as diaminodiphenylmethane and diaminodiphenylpropane. These may be used alone or in combination of two or more kinds thereof. Among them, 1,3-propanediamine, 1,4-diaminobutane, 1,6-hexamethylenediamine and the like are preferable from the viewpoint of the toughness of the intermediate resin layer.

### (Bifunctional Thiol Compound)

The bifunctional thiol compound is a compound having two mercapto groups, and examples thereof include 1,4-bis(3-mercaptobutyryloxy)butane which is a bifunctional secondary thiol compound (for example, “KarenzMT (registered trademark) BD1” (manufactured by Showa Denko K.K.)). The bifunctional thiol compound may be used alone or in combination of two or more kinds thereof.

### (Bifunctional Epoxy Compound)

The bifunctional epoxy compound is a compound having two epoxy groups, and examples thereof include aromatic epoxy resins such as bisphenol A type epoxy resin, bisphenol F type epoxy resin, bisphenol S type epoxy resin, biphenol type epoxy resin, and naphthalene type bifunctional epoxy resin; and aliphatic epoxy compounds such as 1,6-hexanediol diglycidyl ether. These may be used alone or in combination of two or more kinds thereof. Among them, a bisphenol A type epoxy resin is preferable from the viewpoint of the strength of the intermediate resin layer. Specific examples of the commercial products include “jER (registered trademark) 828, 834, 1001, 1004, 1007, and YX-4000” (all manufactured by Mitsubishi Chemical Corporation). Other epoxy compounds having a special structure can also be used as long as they have two functional epoxy groups.

### (Bifunctional Carboxy Compound)

The bifunctional carboxy compound is a compound having two carboxy groups, and examples thereof include oxalic acid, malonic acid, succinic acid, glutaric acid, adipic acid, maleic acid, fumaric acid, isophthalic acid, and terephthalic acid. These may be used alone or in combination of two or more kinds thereof. Among them, isophthalic acid, terephthalic acid, adipic acid, and the like are preferable from the viewpoint of the strength, toughness, and the like of the intermediate resin layer.

### (Radical Polymerizable Monofunctional Monomer)

The radical polymerizable monofunctional monomer is a monomer having one ethylenically unsaturated bond. Examples thereof include styrene-based monomers such as styrene monomer, styrene derivatives such as α-, o-, m- and p-alkyl, nitro, cyano, amide and ester derivatives of styrene, chlorostyrene, vinyltoluene, and divinylbenzene; and (meth)acrylic acid esters such as ethyl (meth)acrylate, methyl (meth)acrylate, n-propyl (meth)acrylate, i-propyl (meth)acrylate, hexyl (meth)acrylate, 2-ethylhexyl (meth)acrylate, lauryl (meth)acrylate, dodecyl (meth)acrylate, cyclopentyl (meth)acrylate, cyclohexyl (meth)acrylate, tetrahydrofuryl (meth)acrylate, acetoacetoxyethyl (meth)acrylate, dicyclopentenyloxyethyl (meth)acrylate, phenoxyethyl (meth)acrylate, and glycidyl (meth)acrylate. These may be used alone or in combination of two or more kinds thereof. Among these, from the viewpoint of the strength and toughness of the intermediate resin layer, one kind or a combination of two or more kinds selected from styrene, methyl (meth)acrylate, 2-ethylhexyl (meth)acrylate, and phenoxyethyl (meth)acrylate is preferable.

In order to allow the radical polymerization reaction to proceed sufficiently and form a desired intermediate resin layer, the in-situ polymerization type composition may contain a solvent and, if necessary, an additive such as a colorant. In this case, it is preferable that the radical polymerizable monofunctional monomer is a main component in components other than the solvent in the in-situ polymerization type composition. The main component means that the content of the radical polymerizable monofunctional monomer is 50 to 100% by mass. The content is preferably 60% by mass or more, and more preferably 80% by mass or more.

The in-situ polymerization type composition preferably contains (d), more preferably contains a bifunctional phenol compound and a bifunctional epoxy resin, still more preferably contains a bisphenol A and a bisphenol A type epoxy resin or a bisphenol S and a bisphenol A type epoxy resin, and even more preferably contains a bisphenol S and a bisphenol A type epoxy resin, from the viewpoint of bonding the metal and the resin with more sufficient bonding strength.

In addition to the above (a) to (g), the in-situ polymerization type composition preferably contains rubber components such as carboxy group-terminated butadiene nitrile rubber and polymers capable of imparting toughness such as aromatic polyetherketone, silicone elastomer, and acrylic resin.

Examples of the aromatic polyether ketone include polyether ether ketone (PEEK).

Examples of the silicone elastomer include “DOWSIL EP-2600” (manufactured by The Dow Chemical Company) and “DOWSIL EP-2601” (manufactured by The Dow Chemical Company).

Examples of the acrylic resin include methyl methacrylate-butadiene styrene-styrene copolymer (MBS) such as “BTA-730” (manufactured by The Dow Chemical Company), and polymethyl methacrylate (PMMA).

When the in-situ polymerization type composition contains a rubber component and a polymer capable of imparting toughness, the toughness of the intermediate resin layer is improved and the impact resistance of the bonded article is improved.

The in-situ polymerization type composition may contain a maleic anhydride-modified polyolefin in addition to the above (a) to (g).

The maleic anhydride-modified polypropylene is polypropylene graft-modified with maleic anhydride. Specific examples of the commercial products include “Kayabrid 002PP”, “Kayabrid 002PP-NW”, “Kayabrid 003PP”, and “Kayabrid 003PP-NW” (all manufactured by Kayaku Nouryon Corporation), and “Modic (registered trademark)” series (manufactured by Mitsubishi Chemical Corporation).

Further, as the maleic anhydride-functionalized polypropylene additives, “SCONA TPPP 2112 GA”, “SCONA TPPP 8112 GA”, and “SCONA TPPP 9212 GA” (all manufactured by BYK) may be used in combination.

In particular, in a case where polypropylene (PP) is used as the resin, the in-situ polymerization type composition preferably contains a maleic anhydride-modified polyolefin.

The in-situ polymerization type composition may contain optional additives such as solvents, colorants, and antioxidants, if necessary. When the in-situ polymerization type composition is in a liquid state, solvents may not be used.

Examples of the solvent include methyl ethyl ketone, methyl isobutyl ketone, acetone, ethyl acetate, toluene, xylene, tetrahydrofuran, and water.

### [Primer Layer]

The thermoplastic resin film in the present embodiment is a film which is interposed between a metal and a resin to be bonded and can bond the metal and the resin by high-frequency induction welding. The film is obtained by causing an in-situ polymerization type composition to undergo at least one reaction selected from a polyaddition reaction and a radical polymerization reaction, and further causes the reaction by the high-frequency induction welding. That is, the film is a film in which the reaction is in the middle (the reaction is not completed).

The primer layer in the present embodiment is a layer that is laminated on a metal, is interposed between the metal and a resin to be bonded, and can bond the metal and the resin by high-frequency induction welding. The primer layer is composed of one layer or a plurality of layers, and at least the outermost surface layer is an in-situ polymerization type polymer layer obtained by polymerizing an in-situ polymerization type composition above the metal. The “outermost surface layer” refers to a surface on the side opposite to the metal, and is a surface that is in direct contact with the resin during bonding. The primer layer causes a chemical reaction by high-frequency induction welding.

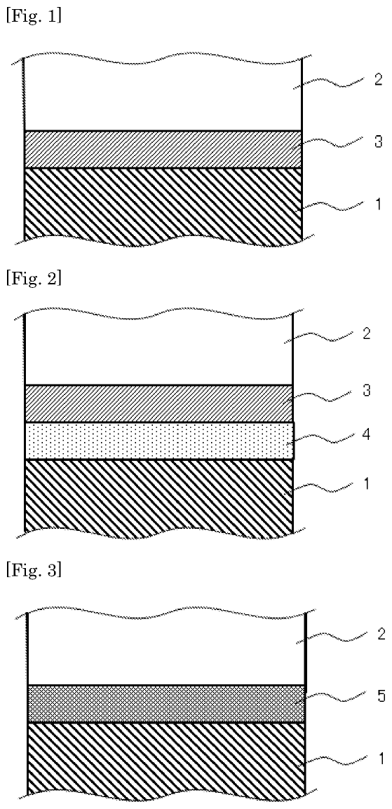

FIG. 1 and FIG. 2 are schematic cross-sectional views of a bonded article formed by bonding between a metal and a resin in which the intermediate resin layer according to one aspect of the present embodiment is a primer layer. The primer layer 3 is preferably laminated in direct contact with the metal 1 as shown in FIG. 1 or via a functional group-containing layer 4 which is a part of the metal 1 as shown in FIG. 2. The functional group layer 4 is a layer formed by the functional group-imparting treatment.

Since the in-situ polymerization type polymer layer is laminated above the metal 1 as the primer layer 3, the metal 1 and the resin can be firmly welded.

The primer layer may be composed of a plurality of layers including the in-situ polymerization type polymer layer.

In addition to the in-situ polymerization type polymer layer, the primer layer may include one or more thermosetting resin layers. Examples of the thermosetting resin constituting the thermosetting resin layer include a urethane resin, an epoxy resin, a vinyl ester resin, and an unsaturated polyester resin. These may be used alone or in combination of two or more kinds thereof.

The thickness of the primer layer is preferably 1 μm to 10 mm, more preferably 10 μm to 8 mm, and still more preferably 50 μm to 5 mm in order to obtain sufficient bonding strength and from the viewpoint of suppressing thermal deformation of the obtained bonded article due to a difference in thermal expansion coefficient between the metal and the resin, although depending on the types of materials of the metal and the resin and the contact area of the bonding portion. When the primer layer is composed of a plurality of layers, the thickness of the primer layer is the sum of the thicknesses of the respective layers.

Each layer of the primer layer may contain optional additives such as a colorant and an antioxidant as necessary within a range in which sufficient bonding strength obtained by high-frequency induction welding of the primer layer can be obtained.

The in-situ polymerization type polymerization layer contained in the primer layer can be obtained by coating a solution containing the in-situ polymerization type composition and a solvent on the metal or the functional group-containing layer, polymerizing the in-situ polymerization type composition by at least one reaction selected from a polyaddition reaction and a radical polymerization reaction, that is, causing a chemical reaction.

A coating method for forming the in-situ polymerization type polymer layer contained in the primer layer is not particularly limited, and for example, an immersion method, a spray coating method, or the like can be used.

In the case of the immersion method, for example, an in-situ polymerization type polymer layer can be formed by immersing the metal in a solution of room temperature to 100° C. at a concentration of about 0.5 to 50% by mass of the in-situ polymerization type composition for 1 minute to 5 days, drying at a temperature within the range of room temperature to 100° C. for 1 minute to 5 hours, and then heating to a temperature within the range of room temperature to 200° C. and allowing to stand for 5 to 120 minutes. In the case where the in-situ polymerization type polymer layer is formed by photocuring, the in-situ polymerization type polymer layer can be formed by irradiating ultraviolet rays or visible light at a temperature within the range of room temperature to 100° C. for 10 seconds to 60 minutes on the metal immersed in the above-mentioned solution for 1 minute to 5 days.

In the case of the spray method, for example, the in-situ polymerization type polymer layer can be formed by spraying a solution at a concentration of about 0.5 to 50% by mass of the in-situ polymerization type composition onto the metal 1, drying at a temperature within the range of room temperature to 100° C. for 1 minute to 5 hours, and then allowing to stand at a temperature within the range of room temperature to 200° C. for 5 to 120 minutes. In the case where the primer layer is formed by photocuring, the in-situ polymerization type polymer layer can be formed by irradiating ultraviolet rays or visible light at a temperature within the range of room temperature to 100° C. for 10 seconds to 60 minutes.

When the primer layer has a layer other than the in-situ polymerization type polymer layer, the method for forming the layer is not particularly limited, and the same method as that for the in-situ polymerization type polymer layer can be used.

### [Thermoplastic Resin Film]

The thermoplastic resin film in the present embodiment is a film which is interposed between a metal and a resin to be bonded and can bond the metal and the resin by high-frequency induction welding. The film is obtained by causing an in-situ polymerization type composition to undergo at least one reaction selected from a polyaddition reaction and a radical polymerization reaction, and further causes the reaction by the high-frequency induction welding. That is, the film is a film in which the reaction is in the middle (the reaction is not completed).

FIG. 3 and FIG. 4 are schematic cross-sectional views of a bonded article formed by bonding between the metal and the resin in which the intermediate resin layer according to another aspect of the present embodiment is a thermoplastic resin film. It should be noted that the thermoplastic resin film 5 shown in FIG. 3 and FIG. 4 is a film in which the reaction is in the middle (the reaction is not completed) before the bonding between the metal and the resin by the high-frequency induction welding, and is a film after the reaction, that is, the chemical reaction is generated by the high-frequency induction welding. The thermoplastic resin film 5 is preferably disposed in direct contact with the metal 1 as shown in FIG. 3 or via the functional group-containing layer 4 which is a part of the metal 1 as shown in FIG. 4.

The method for producing the thermoplastic resin film is not particularly limited, but it can be produced by, for example, coating a release film with a solution obtained by dissolving the in-situ polymerization type composition in a solvent, allowing to stand in an environment of room temperature to 40° C. for 1 minute to 5 hours to vaporize the solvent, and then allowing to stand at room temperature to 200° C. for 1 to 60 minutes to allow the reaction to proceed halfway.

The thickness of the thermoplastic resin film is preferably 1 μm to 5 mm, more preferably 5 μm to 2 mm, and still more preferably 10 μm to 1 mm in order to obtain sufficient bonding strength and from the viewpoint of suppressing thermal deformation of the obtained bonded article due to a difference in thermal expansion coefficient between the metal and the resin, although depending on the types of the metal and the resin and the contact area of the bonding portion.

Further, after the preparation of the thermoplastic resin film, the pulverized thermoplastic resin film is emulsified in water or the like using an emulsifier to form an emulsion, the emulsion is coated onto the metal 1 in the form of an emulsion, and at least one reaction selected from a polyaddition reaction and a radical polymerization reaction proceeds to form the intermediate resin layer.

### [Multilayer Structure Film]

The multilayer structure film in the present embodiment is a film which is interposed between a metal and a resin to be bonded and which is capable of bonding the metal and the resin by high-frequency induction welding. The multilayer structure film includes a thermoplastic resin layer obtained by causing the in-situ polymerization type composition to undergo at least one reaction selected from a polyaddition reaction and a radical polymerization reaction, and a thermosetting resin layer in a B-stage state (semi-cured state). In addition, the thermosetting resin layer in a B-stage state is a layer in which a crosslinking reaction is generated (curing reaction occurs) from the B-stage state (semi-cured state) by high-frequency induction welding, that is, a layer in which a chemical reaction is generated.

FIG. 5 and FIG. 6 are schematic cross-sectional views of a bonded article formed by bonding between the metal and the resin in which the intermediate resin layer according to still another aspect of the present embodiment is a multilayer structure film. It should be noted the multilayer structure film 6 shown in FIG. 5 and FIG. 6 is a film containing a thermosetting resin layer in a B-stage state (semi-cured state) before the bonding between the metal and the resin by the high-frequency induction welding, and is a film after the crosslinking reaction, that is, the chemical reaction is generated by the high-frequency induction welding.

Further, the multilayer structure film 6 is preferably disposed in direct contact with the metal 1 as shown in FIG. 5 or via the functional group-containing layer 4 which is a part of the metal 1 as shown in FIG. 6.

The multilayer structure film may include a layer other than the thermoplastic resin layer and the thermosetting resin layer in a B-stage state.

The thermoplastic resin layer contained in the multilayer structure film may be one in which at least one reaction selected from a polyaddition reaction and a radical polymerization reaction of the in-situ polymerization type composition is completed, or one in which at least one reaction is not completed but the reaction is in the middle.

In the thermosetting resin layer in a B-stage state, it is preferable that an unsaturated group contained in the thermoplastic resin layer undergoes radical polymerization or an epoxy group undergoes ring-opening polymerization by high-frequency induction welding.

Although the production of the multilayer structure film is not particularly limited, for example, the multilayer structure film can be produced by forming the thermoplastic resin layer and then providing a thermosetting resin layer in a B-stage state on the thermoplastic resin layer.

Specifically, the thermoplastic resin layer is formed by coating a release film with a solution obtained by dissolving the in-situ polymerization type composition in a solvent, allowing the solution to stand in an environment of room temperature to 40° C. for 1 minute to 5 hours to volatilize the solvent, and then proceeding with at least one reaction selected from a polyaddition reaction and a radical polymerization reaction for 60 to 120 minutes at room temperature to 200° C. In this case, the temperature may not be constant but may be changed, and the reaction may be completed or the reaction may be in the middle.

Then, it is preferable to produce the multilayer structure film by providing a thermosetting resin layer in a B-stage state on the thermoplastic resin layer by at least one method selected from the following (1) to (4).
(1) The multilayer structure film is produced by adding and mixing a peroxide catalyst for high-temperature curing which functions as a catalyst at 80 to 150° C. and an epoxy curing agent for room-temperature curing which functions as a curing agent at room temperature to 40° C. to a resin having an unsaturated group and an epoxy group to obtain a resin composition, coating the resin composition on the thermoplastic resin layer, and then allowing to stand at room temperature to 40° C. for 1 minute to 10 hours to promote ring-opening polymerization of the epoxy group.
(2) The multilayer structure film is produced by adding and mixing a photoinitiator for the purpose of radical polymerization of unsaturated groups and an epoxy curing agent for high-temperature curing which functions as a curing agent at 80 to 200° C. to a resin having an unsaturated group and an epoxy group to obtain a resin composition, coating the resin composition on the thermoplastic resin layer, irradiating the resin composition with light for 0.1 to 5 minutes to promote radical polymerization of unsaturated groups.
(3) The multilayer structure film is produced by adding and mixing a vinyl ester resin with a peroxide catalyst for high-temperature curing which functions as a catalyst at 80 to 150° C.° C. and a polyisocyanate compound to obtain a resin composition, coating the resin composition on the thermoplastic resin layer, and then allowing to stand at room temperature to 40° C. for 1 to 60 minutes to thereby promote a reaction between the hydroxy group of the vinyl ester resin skeleton and the isocyanate compound.
(4) The multilayer structure film is produced by adding and mixing a vinyl ester resin with a peroxide catalyst for high-temperature curing which functions as a catalyst at 80 to 150° C. and a near-infrared radical polymerization catalyst to obtain a resin composition, coating the resin composition on the thermoplastic resin layer, and then irradiating near infrared rays for 0.5 to 5 minutes to promote radical polymerization of the vinyl ester resin.

Among the above methods (1) to (4), from the viewpoint of adhesiveness between the thermoplastic resin and the thermosetting resin layer in a B-stage state, it is preferable to produce a multilayer structure film by the methods (1) and (3), and the method (3) is more preferable.

In the multilayer structure film, from the viewpoint of obtaining sufficient bonding strength, it is preferable to perform direct bonding of the thermosetting resin layer in a B-stage state with the metal, and it is preferable to perform direct bonding of the thermoplastic resin layer with the resin.

When the multilayer structure film includes a layer other than the thermoplastic resin layer and the thermosetting resin layer in a B-stage state, the other layer is preferably a layer interposed between the thermoplastic resin layer and the thermosetting resin layer in a B-stage state.

The thickness of the multilayer structure film is preferably 1 μm to 10 mm, more preferably 10 μm to 5 mm, and still more preferably 20 μm to 1 mm in order to obtain sufficient bonding strength and from the viewpoint of suppressing thermal deformation of the obtained bonded article due to a difference in thermal expansion coefficient between the metal and the resin, although depending on the types of the metal and the resin and the contact area of the bonding portion.

### <High-Frequency Induction Welding>

As described above, the high-frequency induction welding refers to a method of melting and welding a material from the inside thereof by dielectric heating with high-frequency waves.

The high-frequency induction welding in the present embodiment is performed by arranging the metal and the resin so as to be bonded to each other via the intermediate resin layer. According to the present embodiment, the metal and the resin can be bonded with sufficient bonding strength.

Examples of an apparatus used in the high-frequency induction welding include a high-frequency heating apparatus including a power supply unit and a heating coil unit (high-frequency bar) that generates a strong high-frequency electric field. The high-frequency induction welding apparatus is an apparatus in which when an alternating current is caused to flow through a conducting wire of a heating coil unit, a magnetic field whose direction and strength change is generated around the conducting wire, and a metal placed in the generated magnetic field is heated by Joule heat generated by the electric resistance of the metal when the current flows. As the high-frequency welding apparatus, a known apparatus can be used. Specific examples thereof include electromagnetic induction welders “UH-2.5K”, “UH-5K”, “UHT-1002F”, “UHT-1500”, “UHT-5002”, “UHT-15002”, “UHT-502”, and “UHT-1002” manufactured by Seidensha Electronics Co., Ltd., and a high-frequency welder “PLASEST-8xXD” manufactured by Yamamoto Vinita Co., Ltd.

The oscillation frequency in the high-frequency induction welding is, for example, in the range of 1 to 1500 kHz. The oscillation frequency may be appropriately adjusted according to the sizes and types of the metal and the resin, and the components of the intermediate resin layer.

The output in the high-frequency induction welding is, for example, in the range of 0.1 to 2000 W.

The oscillation time in the high-frequency induction welding may be adjusted depending on the sizes and types of the metal and the resin, and the components of the intermediate resin layer, and is preferably 1.0 to 10.0 seconds, more preferably 1.5 to 8.0 seconds, for example.

### [Bonded Article]

As shown in FIG. 1 to FIG. 6, the bonded article in the present embodiment is formed by bonding between a metal and a resin by high-frequency induction welding via an intermediate resin layer which causes a chemical reaction, and is a bonded article between a metal and a resin obtained by the bonding method of a metal and a resin of the present embodiment.

In one aspect of the present embodiment, it is preferable that the intermediate resin layer in the bonded article is a primer layer laminated on the metal, and at least an outermost surface layer of the primer layer is an in-situ polymerization type polymer layer obtained by polymerizing an in-situ polymerization type composition above the metal.

In another aspect of the present embodiment, it is preferable that the intermediate resin layer in the boded article is a thermoplastic resin film which is obtained by causing an in-situ polymerization type composition to undergo at least one reaction selected from a polyaddition reaction and a radical polymerization reaction, and which further causes the reaction by the high-frequency welding.

In still another aspect of the present embodiment, it is preferable that the intermediate resin layer in the bonded article is a multilayer structure film including: a thermoplastic resin layer obtained by causing an in-situ polymerization type composition to undergo at least one reaction selected from a polyaddition reaction and a radical polymerization reaction; and a thermosetting resin layer in a B-stage state.

### EXAMPLES

Next, specific examples of the present invention will be described, but the present invention is not particularly limited to these examples.

### [Metal Test Piece]

In the following Examples and Comparative Examples, details of metals used for preparing metal test pieces are shown in Table 1. A metal made of each of the following materials was set to a size of 18 mm×45 mm.

TABLE 1

| Material | Detail |
|---|---|
| Aluminum | A6063; thickness 1.5 mm |
| Steel | Steel plate, SPHC (JIS G 3131:2018); thickness 1.6 mm |
| Copper | C1100P (JIS H 3100:2018); thickness 1.5 mm |

### [Resin Test Piece]

In the following Examples and Comparative Examples, the details of each resin used to prepare each resin test piece (10 mm×45 mm×3 mm) are shown below. Each of the resins was injection-molded with an injection-molding machine “SE100V” (manufactured by Sumitomo Heavy Industries, Ltd.) under the conditions shown in Table 2 below to obtain a test piece having a size of 10 mm×45 mm×3 mm.
PA6: polyamide 6, containing 30% by mass of glass fiber, “Novamid (registered trademark)” (manufactured by DSM)
PA66: polyamide 66, containing 30% by mass of glass fiber, “Novamid (registered trademark)” (manufactured by DSM)
PPS: polyphenylene sulfide, containing 40% by mass of glass fiber, “FZ-2140” (manufactured by DIC Corporation)
PC: polycarbonate, “Makrolon (registered trademark) 2405” (manufactured by SABIC)
PBT: polybutylene terephthalate, containing 30% by mass of glass fiber, “Valox 507” (manufactured by SABIC)
PP: polypropylene, containing 30% by mass of talc, “TRC104N” (manufactured by SunAllomer Ltd.)

TABLE 2

| | Cylinder | Mold | Injection | | Cooling |
|---|---|---|---|---|---|
| | temperature | temperature | speed | Dwelling | time |
| Resin | [° C.] | [° C.] | [mm/sec] | [MPa/sec] | [sec] |
| PA6 | 270 | 80 | 50 | 100/4.0 | 15 |
| PA66 | 290 | 80 | 50 | 100/4.0 | 15 |
| PPS | 310 | 140 | 50 | 100/3.0 | 15 |
| PC | 280 | 80 | 100 | 130/10.4 | 30 |
| PBT | 270 | 100 | 65 | 120/5.0 | 15 |
| PP | 210 | 30 | 50 | 195/7.0 | 15 |

### [Pre-Treatment]

### <Etching Treatment>

The metal test piece was immersed in a sodium hydroxide aqueous solution having a concentration of 5% by mass at room temperature for 1.5 minutes, neutralized with a nitric acid aqueous solution having a concentration of 5% by mass, washed with water, and dried, thereby performing the etching treatment.

### <Plasma Treatment>

Plasma treatment was performed on the surface of the metal test piece under the conditions of an irradiation distance of 15 mm and a feed rate of 5 m/min using an atmospheric pressure plasma treatment apparatus “Openair-Plasma (registered trademark) generator FG5001” (manufactured by Plasmatreat GmbH).

### <Functional Group-Imparting Treatment>

### (Functional Group-Imparting Treatment 1)

The metal test piece subjected to the etching treatment or the plasma treatment was immersed in a silane coupling agent-containing solution of 70° C., obtained by dissolving 2 g of 3-aminopropyltrimethoxysilane (silane coupling agent “KBM-903” (manufactured by Shin-Etsu Silicone Co., Ltd.)) in 1000 g of industrial ethanol for 20 minutes. After the immersion, the metal test piece was taken out and dried to obtain a metal test piece to which a functional group was imparted.

### (Functional Group-Imparting Treatment 2)

A metal test piece to which a functional group was imparted was obtained in the same manner as in the functional group-imparting treatment 1 except that 3-aminopropyltrimethoxysilane was changed to 3-methacryloxypropyltrimethoxysilane (silane coupling agent “KBM-503” (manufactured by Shin-Etsu Silicone Co., Ltd.)).

### [Preparation of In-Situ Polymerization Type Composition]

### <In-Situ Polymerization Type Composition 1>

90.1 g of a bifunctional epoxy resin “jER (registered trademark) 1007” (manufactured by Mitsubishi Chemical Corporation), 5.2 g of bisphenol S, 4.6 g of terminal carboxy group butadiene nitrile rubber “Hycar (registered trademark) CTBN1300X13” (manufactured by Lubrizol), and 0.4 g of triphenylphosphine were dissolved in 186 g of methyl ethyl ketone to prepare an in-situ polymerization type composition 1.

### <In-Situ Polymerization Type Composition 2>

5 g of maleic anhydride-modified polypropylene “Modic (registered trademark) ER321P” (manufactured by Mitsubishi Chemical Corporation) and 95 g of xylene were mixed, and the temperature was raised to 125° C. while stirring to dissolve the maleic anhydride-modified polypropylene. Subsequently, 1.01 g of a bifunctional epoxy resin “jER (registered trademark) 1001” (bisphenol A type epoxy resin manufactured by Mitsubishi Chemical Corporation, molecular weight: about 900), 0.24 g of bisphenol A, and 0.006 g of triphenylphosphine were added and dissolved, and then the mixture was cooled to room temperature to obtain an in-situ polymerization type composition 2.

[Preparation of Metal Test Piece with Primer Layer]
<Metal Test Piece with Primer Layer Using In-Situ Polymerization Type Composition 1>

As the pre-treatment, the in-situ polymerization type composition 1 was coated by a spray method onto the surface of one side of the metal test piece subjected to the etching treatment or the plasma treatment and the functional group-imparting treatment 1 so as to be 20 μm thick after drying. After allowing to stand in the air at room temperature for 30 minutes to vaporize the solvents, a polyaddition reaction was carried out in a furnace at a temperature of 150° C. for 10 minutes, and then cooled to room temperature to form a primer layer on the surface of one side of the metal test piece, thereby obtaining a test piece with a primer.

<Metal Test Piece with Primer Layer Using In-Situ Polymerization Type Composition 2>

A metal test piece with a primer layer was obtained in the same manner as above except that the in-situ polymerization type composition 2 was used in place of the in-situ polymerization type composition 1 in the metal test piece 1 with a primer layer.

<Metal Test Piece with Primer Layer Using Adhesive 1>

As a pre-treatment, a polyamide hot-melt adhesive “TEC7785-12” (adhesive 1 manufactured by Nagase Chemtex Corporation) melted at 180° C. was coated onto the surface of one side of the metal test piece subjected to only etching treatment or etching treatment and functional group-imparting treatment 1 by leveling with a rod using a 20 μm spacer in a 180° C. dryer so as to have a thickness of 20 μm, thereby obtaining a metal test piece with a primer layer.

<Metal Test Piece with Primer Layer Using Adhesive 2>

As a pre-treatment, an acrylic hot-melt adhesive “UX801” (adhesive 2 manufactured by Nagase Chemtex Corporation) melted at 180° C. was coated onto the surface of one side of the metal test piece subjected to only plasma treatment or plasma treatment and functional group-imparting treatment 1 by leveling with a rod using a 20 μm spacer in a 180° C. dryer so as to have a thickness of 20 μm, thereby obtaining a metal test piece with a primer layer.

### [Preparation of In-Situ Polymerization Type Thermoplastic Resin Film]

### <In-Situ Polymerization Type Thermoplastic Resin Film 1>

The in-situ polymerization type composition 1 was coated onto a PTFE film, which is a release film, by a spray method so as to have a thickness of 30 μm after drying, allowed to stand in the air at room temperature for 30 minutes to volatilize the solvent, and then a polyaddition reaction was slightly proceeded in a furnace at a temperature of 100° C. for 5 minutes, and was allowed to cool to room temperature, and was peeled off from the release film to obtain an in-site polymerization type thermoplastic resin film 1 in which a room for polymerization reaction was left (in a semi-cured state).

### <In-Situ Polymerization Type Thermoplastic Resin Film 2>

An in-situ polymerization type thermoplastic resin film 2 in which a room for polymerization reaction was left was prepared in the same manner as the preparation of the in-situ polymerization type thermoplastic resin film 1 except that the polyaddition reaction was proceeded in a furnace at a temperature of 150° C. for 5 minutes.

### [Preparation of Polymerization Completion Type Thermoplastic Resin Film]

### <Polymerization Completion Type Thermoplastic Resin Film 1>

The in-situ polymerization type composition 1 was coated onto a PTFE film, which is a release film, by a spray method so as to have a thickness of 30 μm after drying, allowed to stand in the air at room temperature for 30 minutes to volatilize the solvent, and then a polyaddition reaction was proceeded in a furnace at a temperature of 160° C. for 2 hours, and was allowed to cool to room temperature, and was peeled off from the release film to obtain a completely polymerized (polyaddition reaction was completed) polymerization completion type thermoplastic resin film.

### [Preparation of Two-Layer Structure Film]

### <Two-Layer Structure Film 1>

185 g (1.0 equivalent) of “jER (registered trademark) 1007” (manufactured by Mitsubishi Chemical Corporation), 10.75 g (⅛ equivalent) of methacrylic acid, and 0.4 g of triphenylphosphine as a catalyst were mixed to obtain a resin having a methacryloyl group, a hydroxy group, and an epoxy group subjected to an addition reaction. 1.0 g of a peroxide catalyst “Perbutyl Z” (manufactured by NOF Corporation) and 118 g of an epoxy curing agent thiol compound “KarenzMT (registered trademark) PE1” (manufactured by Showa Denko K.K.) were added and mixed with the above resin to prepare a thermosetting resin composition 1.

Subsequently, the in-situ polymerization type composition 1 was coated onto a PTFE film, which is a release film, by a spray method so as to have a thickness of 30 μm after drying, allowed to stand in the air at room temperature for 30 minutes to volatilize the solvent, and then a polyaddition reaction was proceeded in a furnace at a temperature of 150° C. for 10 minutes. Thereafter, the composition was allowed to cool to room temperature, and then the polyaddition reaction was proceeded again in a furnace at a temperature of 150° C. for 1 hour, and then allowed to cool to room temperature to obtain a thermoplastic resin film i in which the polyaddition reaction was completed. The thermosetting resin composition 1 was coated onto the obtained thermoplastic resin film i so as to have a thickness of 30 μm after drying, and allowed to stand at room temperature for 3 hours to cure the epoxy group at room temperature, and then the PTFE film was peeled off to obtain a two-layer structure film 1 (radical polymerizable type) having a thermoplastic resin layer and a thermosetting resin layer in a B-stage state.

### <Two-Layer Structure Film 2>

185 g (1.0 equivalent) of “jER (registered trademark) 1007” (manufactured by Mitsubishi Chemical Corporation), 75.25 g (⅞ equivalent) of methacrylic acid, and 0.4 g of triphenylphosphine as a catalyst were mixed to obtain a resin having a methacryloyl group, a hydroxy group, and an epoxy group subjected to a polyaddition reaction. 1.0 g of a peroxide catalyst “328E” (manufactured by Kayaku Nouryon Corporation), 0.5 g of cobalt octylate, and 2.0 g of 2-ethyl-4-methylimidazole “Curezol 2E4MZ” (manufactured by Shikoku Chemicals Corporation) as an epoxy curing agent were mixed with the resin to obtain a thermosetting resin composition 2.

Subsequently, the thermosetting resin composition 2 was coated onto the thermoplastic resin film i prepared in the same manner as described above so as to have a thickness of 20 μm after drying, and allowed to stand at room temperature for 3 hours to cure the methacryloyl group at room temperature, and then the PTFE film was peeled off to obtain a two-layer structure film 2 (epoxy curing type) having a thermoplastic resin layer and a thermosetting resin layer in a B-stage state.

### <Two-Layer Structure Film 3>

A thermosetting resin composition 3 was obtained by mixing 3.0 g of diphenylmethane diisocyanate “Millionate MR-100” (manufactured by Tosoh Corporation) and 1.0 g of peroxide catalyst “Perbutyl Z” (manufactured by NOF Corporation) with 100 g of vinyl ester resin “Ripoxy (registered trademark) R-806” (manufactured by Showa Denko K.K.).

Subsequently, the thermosetting resin composition 3 was coated onto the thermoplastic resin film i so as to have a thickness of 20 μm after drying, and was allowed to stand at 40° C. for 3 hours to react an isocyanato group and a hydroxy group, and then the PTFE film was peeled off to obtain a two-layer structure film 3 (radical polymerization type) having a thermoplastic resin layer and a thermosetting resin layer in a B-stage state.

### <Two-Layer Structure Film 4>

The thermosetting resin composition 3 was coated onto the thermoplastic resin film so as to have a thickness of 20 μm after drying, and was allowed to stand at 40° C. for 3 hours to react an isocyanato group and a hydroxy group, and then radical polymerization was further proceeded in a furnace at 120° C. for 1 hour, and after being allowed to stand at room temperature for 1 hour, the PTFE film was peeled off to obtain a two-layer structure film 4 having a thermoplastic resin layer and a completely cured (C-stage state) thermosetting resin layer.

### Example 1-1

### (Welding)

A metal-resin bonded article test piece P1-1 was prepared by performing high-frequency electromagnetic induction welding at an oscillation frequency of 900 kHz, an output adjusting tap 4, an applied pressure of 150 N, and an oscillation time shown in Table 3, using an electromagnetic induction welder “UHT-1002F” (manufactured by Seidensha Electronics Co., Ltd.) and an oscillator “UH-2.5K” (manufactured by Seidensha Electronics Co., Ltd.) in a state in which a metallic material was aluminum, an etching treatment and a functional group-imparting treatment 1 were performed as surface treatment, a surface of a metal test piece with a primer layer, which used an in-situ polymerization type composition 1 as a primer layer, and one surface of a resin test piece using PA6 as a resin were superimposed so as to have a bonding section of 1 cm×0.5 cm. Here, the bonding section means a portion where the metal test piece and the resin test piece are superimposed.

### (Tensile Shear Strength)

After the obtained test piece P1-1 was allowed to stand at room temperature for 1 day, a tensile shear strength test was performed by a tensile tester (universal tester autograph “AG-IS” (manufactured by Shimadzu Corporation); load cell 10 kN, tensile speed 5 mm/min, temperature 23° C., 50% RH) in accordance with JIS K 6850:1999 to measure the bonding strength. The measurement results are shown in Table 3.

### Examples 1-2 to 1-6

Metal-resin bonded article test pieces P1-2 to P1-6 were prepared in the same manner as in Example 1-1 except that the combination of the metal, the primer layer, and the resin as shown in Table 3 and the oscillation time as shown in Table 3 were used. In addition, a tensile shear test was performed in the same manner as in Example 1-1 except that the obtained test pieces P1-2 to P1-6 were used instead of the test piece P1-1. The measurement results are shown in Table 3.

### Comparative Example 1-1

### (Welding)

High-frequency induction welding was attempted in the same manner as in Example 1-1 except that a metal test piece (without a primer layer) in which the material of the metal was aluminum and only the etching treatment was performed as the surface treatment was used instead of the metal test piece with the primer layer in which the material of the metal was aluminum and the etching treatment and the functional group-imparting treatment 1 were performed as the surface treatment. However, bonding could not be achieved.

### Comparative Examples 1-2 and 1-5

Metal-resin bonded article test pieces Q1-2 and Q1-5 were prepared in the same manner as in Example 1-1 except that the combination of the metal, the primer layer, and the resin as shown in Table 3 and the oscillation time as shown in Table 3 were used. In addition, a tensile shear test was performed in the same manner as in Example 1-1 except that the obtained test pieces Q1-2 and Q1-5 were used instead of the test piece P1-1. The measurement results are shown in Table 3.

### Comparative Examples 1-3, 1-4, and 1-6

High-frequency induction welding was attempted in the same manner as in Comparative Example 1-1 except that the combination of the metal and the resin as shown in Table 3 and the oscillation time as shown in Table 3 were used, but bonding could not be achieved without the primer layer.

### Comparative Example 2-1

### (Welding)

A metal-resin bonded article test piece Q2-1 was prepared in the same manner as in Example 1-1 except that a metal test piece (without a primer layer) in which the material of the metal was aluminum and the etching treatment and the functional group-imparting treatment 1 were performed as the surface treatment was used instead of the metal test piece with the primer layer in which the material of the metal was aluminum, the etching treatment and the functional group-imparting treatment 1 were performed as the surface treatment, and the in-situ polymerization type composition 1 was used as the primer layer.

### (Tensile Shear Strength)

A tensile shear test was performed in the same manner as in Example 1-1 except that the test piece Q2-1 was used instead of the test piece P1-1. The measurement results are shown in Table 3.

### Comparative Examples 2-2 and 2-5

Metal-resin bonded article test pieces Q2-2 and Q2-5 were prepared in the same manner as in Example 1-1 except that the combination of the metal, the primer layer, and the resin as shown in Table 3 and the oscillation time as shown in Table 3 were used. In addition, a tensile shear test was performed in the same manner as in Example 1-1 except that the obtained test pieces Q2-2 and Q2-5 were used instead of the test piece P1-1. The measurement results are shown in Table 3.

### Comparative Examples 2-3, 2-4, and 2-6

High-frequency induction welding was attempted in the same manner as in Comparative Example 2-1 except that the combination of the metal and the resin as shown in Table 3 and the oscillation time as shown in Table 3 were used. As a result, without the primer layer, it was possible to bond in the case of using PC as the resin, and to obtain a metal-resin bonded article test piece Q2-4, but it was not possible to bond in the cases of using PPS and PP.

With respect to the test piece Q2-4, a tensile shear test was performed in the same manner as in Example 1-1 except that the test piece Q2-4 was used instead of the test piece P1-1. The measurement results are shown in Table 3.

TABLE 3

| | | Example 1-1 | Example 1-2 | Example 1-3 | Example 1-4 | Example 1-5 | Example 1-6 |
|---|---|---|---|---|---|---|---|
| Metal | Material | Aluminum | Aluminum | Steel | Steel | Copper | Aluminum |
| | Surface | Etching treatment | Etching treatment | Plasma treatment | Plasma treatment | Plasma treatment | Etching treatment |
| | treatment | Functional group- | Functional group- | Functional group- | Functional group- | Functional group- | Functional group- |
| | | imparting | imparting | imparting | imparting | imparting | imparting |
| | | treatment 1 | treatment 1 | treatment 1 | treatment 1 | treatment 1 | treatment 1 |
| Primer layer | | In-situ | In-situ | In-situ | In-situ | In-situ | In-situ |
| | | polymerization | polymerization | polymerization | polymerization | polymerization | polymerization |
| | | type | type | type | type | type | type |
| | | composition 1 | composition 1 | composition 1 | composition 1 | composition 1 | composition 2 |
| Resin Material | | PA6 | PA66 | PPS | PC | PBT | PP |
| Oscillation time (sec) | | 4.75 | 5.50 | 5.75 | 4.50 | 5.75 | 4.15 |
| Tensile shear | | 42 | 39 | 38 | 33 | 41 | 9 |
| strength (MPa) | | | | | | | |

| | | Comparative | Comparative | Comparative | Comparative | Comparative | Comparative |
|---|---|---|---|---|---|---|---|
| | | Example 1-1 | Example 1-2 | Example 1-3 | Example 1-4 | Example 1-5 | Example 1-6 |
| Metal | Material | Aluminum | Aluminum | Steel | Steel | Copper | Aluminum |
| | Surface | Etching treatment | Etching treatment | Plasma treatment | Plasma treatment | Plasma treatment | Etching treatment |
| | treatment | | | | | | |
| Primer layer | | absent | Adhesive 1 | absent | absent | Adhesive 2 | absent |
| Resin | Material | PA6 | PA66 | PPS | PC | PBT | PP |
| Oscillation time (sec) | | 4.75 | 5.50 | 5.75 | 4.50 | 5.75 | 4.15 |
| Tensile shear | | — | 15 | — | — | 18 | — |
| strength (MPa) | | | | | | | |
| | | Comparative | Comparative | Comparative | Comparative | Comparative | Comparative |
| | | Example 2-1 | Example 2-2 | Example 2-3 | Example 2-4 | Example 2-5 | Example 2-6 |
| Metal | Material | Aluminum | Aluminum | Steel | Steel | Copper | Aluminum |
| | Surface | Etching treatment | Etching treatment | Plasma treatment | Plasma treatment | Plasma treatment | Etching treatment |
| | treatment | Functional group- | Functional group- | Functional group- | Functional group- | Functional group- | Functional group- |
| | | imparting | imparting | imparting | imparting | imparting | imparting |
| | | treatment 1 | treatment 1 | treatment 1 | treatment 1 | treatment 1 | treatment 1 |
| Primer layer | | absent | Adhesive 1 | absent | absent | Adhesive 2 | absent |
| Resin | Material | PA6 | PA66 | PPS | PC | PBT | PP |

| | | | | | | |
|---|---|---|---|---|---|---|
| Oscillation time (sec) | 4.75 | 5.50 | 5.75 | 4.50 | 5.75 | 4.15 |
| Tensile shear | 0.2 | 16 | — | 0.3 | 19 | — |
| strength (MPa) | | | | | | |

### Example 2-1

### (Welding)

A metal-resin bonded article test piece F2-1 was prepared by performing high-frequency electromagnetic induction welding in the same manner as in Example 1-1, in a state in which the in-situ polymerization type thermoplastic resin film 1 was sandwiched between one surface of a metal test piece in which aluminum was used as the metal and subjected to the etching treatment and the functional group-imparting treatment 1 and one surface of a resin test piece in which PA6 was used as a resin, and the respective bonding sections were superimposed to be 1 cm×0.5 cm in size.

### (Tensile Shear Strength)

A tensile shear test was performed in the same manner as in Example 1-1 except that the test piece F2-1 was used instead of the test piece P1-1. The measurement results are shown in Table 4.

### Examples 2-2 to 2-5

Metal-resin bonded article test pieces F2-2 to F2-5 were prepared in the same manner as in Example 2-1 except that the combination of the metal and the resin as shown in Table 4 and the oscillation time as shown in Table 4 were used. In addition, a tensile shear test was performed in the same manner as in Example 1-1 except that the test pieces F2-2 to F2-5 were used instead of the test piece P1-1. The measurement results are shown in Table 4.

### Example 3-1

### (Welding)

A metal-resin bonded article test piece F3-1 was prepared in the same manner as in Example 2-1 except that the in-situ polymerization type thermoplastic resin film 2 was used instead of the in-situ polymerization type thermoplastic resin film 1.

### (Tensile Shear Strength)

A tensile shear test was performed in the same manner as in Example 1-1 except that the test piece F3-1 was used instead of the test piece P1-1. The measurement results are shown in Table 4.

### Examples 3-2 to 3-5

Metal-resin bonded article test pieces F3-2 to F3-5 were prepared in the same manner as in Example 3-1 except that the combination of the metal and the resin as shown in Table 5 and the oscillation time as shown in Table 5 were used. In addition, a tensile shear test was performed in the same manner as in Example 1-1 except that the test pieces F3-2 to F3-5 were used instead of the test piece P1-1. The measurement results are shown in Table 4.

TABLE 4

| | | Example 2-1 | Example 2-2 | Example 2-3 | Example 2-4 | Example 2-5 |
|---|---|---|---|---|---|---|
| Metal | Material | Aluminum | Aluminum | Steel | Steel | Copper |
| | Surface | Etching treatment | Etching treatment | Plasma treatment | Plasma treatment | Plasma treatment |
| | treatment | Functional group- | Functional group- | Functional group- | Functional group- | Functional group- |
| | | imparting | imparting | imparting | imparting | imparting |
| | | treatment 1 | treatment 1 | treatment 1 | treatment 1 | treatment 1 |
| Film | | In-situ | In-situ | In-situ | In-situ | In-situ |
| | | polymerization type | polymerization type | polymerization type | polymerization type | polymerization type |
| | | thermoplastic resin | thermoplastic resin | thermoplastic resin | thermoplastic resin | thermoplastic resin |
| | | film 1 | film 1 | film 1 | film 1 | film 1 |
| Resin | Material | PA6 | PA66 | PPS | PC | PBT |
| Oscillation time (sec) | | 4.75 | 5.50 | 5.75 | 4.50 | 5.75 |
| Tensile shear | | 40 | 37 | 37 | 32 | 40 |
| strength (MPa) | | | | | | |
| | | Example 3-1 | Example 3-2 | Example 3-3 | Example 3-4 | Example 3-5 |
| Metal | Material | Aluminum | Aluminum | Steel | Steel | Copper |
| | Surface | Etching treatment | Etching treatment | Plasma treatment | Plasma treatment | Plasma treatment |
| | treatment | Functional group- | Functional group- | Functional group- | Functional group- | Functional group- |
| | | imparting | imparting | imparting | imparting | imparting |
| | | treatment 1 | treatment 1 | treatment 1 | treatment 1 | treatment 1 |
| Film | | In-situ | In-situ | In-situ | In-situ | In-situ |
| | | polymerization type | polymerization type | polymerization type | polymerization type | polymerization type |
| | | thermoplastic resin | thermoplastic resin | thermoplastic resin | thermoplastic resin | thermoplastic resin |
| | | film 2 | film 2 | film 2 | film 2 | film 2 |
| Resin | Material | PA6 | PA66 | PPS | PC | PBT |

| | | | | | |
|---|---|---|---|---|---|
| Oscillation time (sec) | 4.75 | 5.50 | 5.75 | 4.50 | 5.75 |
| Tensile shear | 37 | 34 | 34 | 30 | 37 |
| strength (MPa) | | | | | |

### Example 4-1

### (Welding)

A metal-resin bonded article test piece F4-1 was prepared in the same manner as in Example 2-1 except that a metal test piece in which aluminum was used as the metal and the etching treatment and the functional group-imparting treatment 2 were performed as the surface treatment was used instead of the metal test piece in which aluminum was used as the metal and the etching treatment and the functional group-imparting treatment 1 were performed as the surface treatment, and the two-layer structure film 1 was used instead of the in-situ polymerization type thermoplastic resin film 1, and the surface of one side of the metal test piece was superimposed so that the thermosetting resin layer in a B-stage state of the two-layer structure film 1 contacted each other.

### (Tensile Shear Strength)

With respect to the test piece F4-1, a tensile shear test was performed in the same manner as in Example 1-1 except that the test piece F4-1 was used instead of the test piece P1-1. The measurement results are shown in Table 5.

### Examples 4-2 to 4-5

Test pieces F4-2 to F4-5 were prepared in the same manner as in Example 4-1 except that the combination of the metal and the resin as shown in Table 6 and the oscillation time as shown in Table 6 were used. In addition, a tensile shear strength test was performed in the same manner as in Example 1-1 except that the test pieces F4-2 to F4-5 were used instead of the test piece P1-1. The measurement results are shown in Table 5.

### Example 5-1

### (Welding)

A metal-resin bonded article test piece F5-1 was prepared in the same manner as in Example 4-1 except that a metal test piece in which aluminum was used as the metal and the etching treatment and the functional group-imparting treatment 1 were performed as the surface treatment was used instead of the metal test piece in which aluminum was used as the metal and the etching treatment and the functional group-imparting treatment 2 were performed as the surface treatment, and the two-layer structure film 2 was used instead of the two-layer structure film 1, and the surface of one side of the metal test piece was superimposed so that the thermosetting resin layer in a B-stage state of the two-layer structure film 2 contacted each other.

### (Tensile Shear Strength)

With respect to the test piece F5-1, a tensile shear strength test was performed in the same manner as in Example 1-1 except that the test piece F5-1 was used instead of the test piece P1-1. The measurement results are shown in Table 5.

### Examples 5-2 to 5-5

Metal-resin bonded article test pieces F5-2 to F5-5 were prepared in the same manner as in Example 5-1 except that the combination of the metal and the resin as shown in Table 5 and the oscillation time as shown in Table 5 were used. In addition, a tensile shear strength test was performed in the same manner as in Example 1-1 except that the test pieces F5-2 to F5-5 were used instead of the test piece P1-1. The measurement results are shown in Table 5.

### Example 6-1

### (Welding)

A metal-resin bonded article test piece F6-1 was prepared in the same manner as in Example 4-1 except that the two-layer structure film 3 was used instead of the two-layer structure film 1, and the surface of one side of the metal test piece was superimposed so that the thermosetting resin layer in a B-stage state of the two-layer structure film 3 contacted each other.

### (Tensile Shear Strength)

With respect to the test piece F6-1, a tensile shear strength test was performed in the same manner as in Example 1-1 except that the test piece F6-1 was used instead of the test piece P1-1. The measurement results are shown in Table 5.

### Examples 6-2 to 6-5

Test pieces F6-2 to F6-5 were prepared in the same manner as in Example 6-1 except that the combination of the metal and the resin as shown in Table 5 and the oscillation time as shown in Table 5 were used. In addition, a tensile shear strength test was performed in the same manner as in Example 1-1 except that the test pieces F6-2 to F6-5 were used instead of the test piece P1-1. The measurement results are shown in Table 5.

TABLE 5

| | | Example 4-1 | Example 4-2 | Example 4-3 | Example 4-4 | Example 4-5 |
|---|---|---|---|---|---|---|
| Metal | Material | Aluminum | Aluminum | Steel | Steel | Copper |
| | Surface | Etching treatment | Etching treatment | Plasma treatment | Plasma treatment | Plasma treatment |
| | treatment | Functional group- | Functional group- | Functional group- | Functional group- | Functional group- |
| | | imparting | imparting | imparting | imparting | imparting |
| | | treatment 2 | treatment 2 | treatment 2 | treatment 2 | treatment 2 |
| Film | | Two-layer structure | Two-layer structure | Two-layer structure | Two-layer structure | Two-layer structure |
| | | film 1 | film 1 | film 1 | film 1 | film 1 |
| Resin | Material | PA6 | PA66 | PPS | PC | PBT |
| Oscillation time (sec) | | 4.75 | 5.50 | 5.75 | 4.50 | 5.75 |
| Tensile shear | | 40 | 38 | 38 | 32 | 40 |
| strength (MPa) | | | | | | |
| | | Example 5-1 | Example 5-2 | Example 5-3 | Example 5-4 | Example 5-5 |
| Metal | Material | Aluminum | Aluminum | Steel | Steel | Copper |
| | Surface | Etching treatment | Etching treatment | Plasma treatment | Plasma treatment | Plasma treatment |
| | treatment | Functional group- | Functional group- | Functional group- | Functional group- | Functional group- |
| | | imparting | imparting | imparting | imparting | imparting |
| | | treatment 1 | treatment 1 | treatment 1 | treatment 1 | treatment 1 |
| Film | | Two-layer structure | Two-layer structure | Two-layer structure | Two-layer structure | Two-layer structure |
| | | film 2 | film 2 | film 2 | film 2 | film 2 |
| Resin | Material | PA6 | PA66 | PPS | PC | PBT |
| Oscillation time (sec) | | 4.75 | 5.50 | 5.75 | 4.50 | 5.75 |
| Tensile shear | | 38 | 36 | 37 | 30 | 38 |
| strength (MPa) | | | | | | |
| | | Example 6-1 | Example 6-2 | Example 6-3 | Example 6-4 | Example 6-5 |
| Metal | Material | Aluminum | Aluminum | Steel | Steel | Copper |
| | Surface | Etching treatment | Etching treatment | Plasma treatment | Plasma treatment | Plasma treatment |
| | treatment | Functional group- | Functional group- | Functional group-- | Functional group- | Functional group- |
| | | imparting | imparting | imparting | imparting | imparting |
| | | treatment 2 | treatment 2 | treatment 2 | treatment 2 | treatment 2 |
| Film | | Two-layer structure | Two-layer structure | Two-layer structure | Two-layer structure | Two-layer structure |
| | | film 3 | film 3 | film 3 | film 3 | film 3 |
| Resin | Material | PA6 | PA66 | PPS | PC | PBT |

| | | | | | |
|---|---|---|---|---|---|
| Oscillation time (sec) | 4.75 | 5.50 | 5.75 | 4.50 | 5.75 |
| Tensile shear | 40 | 39 | 39 | 33 | 41 |
| strength (MPa) | | | | | |

### Comparative Examples 3-1 and 3-2

### (Welding)

Metal-resin bonded article test pieces Q3-1 and Q3-2 were prepared in the same manner, for Comparative Example 3-1, as in Example 2-1 except that a nylon film “Rayfan R NO1401” (manufactured by Toray Advanced Film Co., Ltd., thickness 30 μm) was used instead of the in-situ polymerization type thermoplastic resin film 1, and for Comparative Example 3-2, as in Example 2-2 except that the nylon film was used instead of the in-situ polymerization type thermoplastic resin film 1.

### (Tensile Shear Strength)

A tensile shear test was performed in the same manner as in Example 1-1 except that the test pieces Q3-1 and Q3-2 were used instead of the test piece P1-1. The measurement results are shown in Table 6.

### Comparative Examples 3-3 and 3-4

Metal-resin bonded article test pieces Q3-3 and Q3-4 were prepared in the same manner as in Example 2-1 except that the combination of the metal, the film, and the resin as shown in Table 6 and the oscillation time as shown in Table 6 were used. In addition, a tensile shear strength test was performed in the same manner as in Example 1-1 except that the test pieces Q3-3 and Q3-4 were used instead of the test piece P1-1. The measurement results are shown in Table 6.

### Comparative Example 3-5

Bonding was attempted in the same manner as in Example 5-5 except that the combination of the metal, the film, and the resin as shown in Table 6 and the oscillation time as shown in Table 6 were used, but bonding could not be achieved.

TABLE 6

| | | Comparative | Comparative | Comparative | Comparative | Comparative |
|---|---|---|---|---|---|---|
| | | Example 3-1 | Example 3-2 | Example 3-3 | Example 3-4 | Example 3-5 |
| Metal | Material | Aluminum | Aluminum | Steel | Steel | Copper |
| | Surface | Etching treatment | Etching treatment | Plasma treatment | Plasma treatment | Plasma treatment |
| | treatment | Functional group- | Functional group- | Functional group- | Functional group- | Functional group- |
| | | imparting | imparting | imparting | imparting | imparting |
| | | treatment 1 | treatment 1 | treatment 1 | treatment 1 | treatment 1 |
| Film | | Nylon film | Nylon film | Polymerization | Polymerization | Two-layer |
| | | | | completion type | completion type | structure film 4 |
| | | | | thermoplastic | thermoplastic | |
| | | | | resin film 1 | resin film 1 | |
| Resin | Material | PA6 | PA66 | PPS | PC | PBT |

| | | | | | |
|---|---|---|---|---|---|
| Oscillation time (sec) | 4.75 | 5.50 | 5.75 | 4.50 | 5.75 |
| Tensile shear | 7 | 4 | 18 | 23 | — |
| strength (MPa) | | | | | |

### INDUSTRIAL APPLICABILITY

The use of the bonded article using the method for bonding a metal and a resin according to the present invention is not particularly limited, but can be applied to, for example, automotive parts such as door side panels, bonnet roofs, tailgate, steering hangers, A-pillars, B-pillars, C-pillars, D-pillars, crash boxes, power control unit (PCU) housings, electric compressor members (inner wall portions, intake port portions, exhaust control valve (ECV) insertion portions, mount boss portions, and the like), lithium ion battery (LIB) spacers, battery cases, and LED headlamps, smartphones, notebook computers, tablet personal computers, smart watches, large liquid crystal televisions (LCD-TV), and outdoor LED lighting structures.

In particular, among the bonded articles according to the present invention, the bonded article formed by bonding CFRP and a metal can be suitably applied for use of a multi-material material such as an automobile. Further, the bonded article formed by bonding FRP and a copper foil is also suitable for use as an electronic material substrate.

### REFERENCE SIGNS LIST

1 Metal
2 Resin
3 Primer layer
4 Functional group-containing layer
5 In-situ polymerization type thermoplastic resin film
6 Multilayer structure film
61 Thermosetting resin layer
62 Thermoplastic resin layer

1. A method for bonding a metal and a resin, comprising: bonding a metal and a resin by high-frequency induction welding via an intermediate resin layer which causes a chemical reaction by high-frequency induction welding.

2. The method for bonding a metal and a resin according to claim 1, wherein the intermediate resin layer is a primer layer laminated on the metal, and at least an outermost surface layer of the primer layer is an in-situ polymerization type polymer layer obtained by polymerizing an in-situ polymerization type composition above the metal.

3. The method for bonding a metal and a resin according to claim 1, wherein the intermediate resin layer is a thermoplastic resin film which is obtained by causing an in-situ polymerization type composition to undergo at least one reaction selected from a polyaddition reaction and a radical polymerization reaction, and which further causes the reaction by the high-frequency welding.

4. The method for bonding a metal and a resin according to claim 1, wherein the intermediate resin layer is a multilayer structure film comprising: a thermoplastic resin layer obtained by causing an in-situ polymerization type composition to undergo at least one reaction selected from a polyaddition reaction and a radical polymerization reaction; and a thermosetting resin layer in a B-stage state.

5. The method for bonding a metal and a resin according to claim 2, wherein the in-situ polymerization type composition contains at least one member selected from the following (a) to (g):
(a) a combination of a bifunctional isocyanate compound and a bifunctional hydroxy compound;
(b) a combination of a bifunctional isocyanate compound and a bifunctional amino compound;
(c) a combination of a bifunctional isocyanate compound and a bifunctional thiol compound;
(d) a combination of a bifunctional epoxy compound and a bifunctional hydroxy compound;
(e) a combination of a bifunctional epoxy compound and a bifunctional carboxy compound;
(f) a combination of a bifunctional epoxy compound and a bifunctional thiol compound;
(g) a combination of monofunctional radical polymerizable monomers.

6. The method for bonding a metal and a resin according to claim 5, wherein the in-situ polymerization type composition further comprises a maleic anhydride modified polyolefin.

7. The method for bonding a metal and a resin according to claim 5, wherein the in-situ polymerization type composition further comprises at least one selected from a carboxy group-terminated butadiene nitrile rubber, an aromatic polyetherketone, a silicone elastomer, and an acrylic resin.

8. The method for bonding a metal and a resin according to claim 4, wherein the thermosetting resin layer in a B-stage state causes a crosslinking reaction by the high-frequency welding.

9. The method for bonding a metal and a resin according to claim 4, wherein the thermosetting resin layer in a B-stage state of the multilayer structure film is directly bonded to the metal, and the thermoplastic resin layer of the multilayer structure film is directly bonded to the resin.

10. The method for bonding a metal and a resin according to claim 4, wherein the thermosetting resin layer in a B-stage state is formed by radical polymerization of an unsaturated group or ring-opening polymerization of an epoxy group.

11. The method for bonding a metal and a resin according to claim 1, wherein the bonding surface of the metal on the resin side is subjected to at least one surface treatment selected from a degreasing treatment, an etching treatment, a plasma treatment, a corona discharge treatment, a UV ozone treatment, and a functional group-imparting treatment.

12. The method for bonding a metal and a resin according to claim 11, wherein the functional group-imparting treatment is a treatment of imparting a functional group to a surface of the metal by reacting a compound corresponding to at least one selected from the following (i) to (iii):
(i) an alkoxysilane compound;
(ii) a compound having at least one functional group selected from an amino group, an epoxy group, a mercapto group, and an isocyanato group; and
(iii) a compound having a radical reactive group.

13. A bonded article of a metal and a resin obtained by the method for bonding a metal and a resin according to claim 1.
